(19) United States
(12) Patent Application Publication
(10) Pub. No.: US 2011/0178756 A1
(43) Pub. Date: Jul. 21, 2011

(54) Integrated, Predictive, Radiance Sensor Apparatus and Method

(75) Inventor: Robert Anderson, Richmond, UT (US)

(73) Assignee: Utah State University Research Foundation, North Logan, UT (US)

(21) Appl. No.: 12/365,706

(22) Filed: Feb. 4, 2009

Related U.S. Application Data
(60) Provisional application No. 61/026,424, filed on Feb. 5, 2008.
(60) Provisional application No. 61/148,136, filed on Jan. 29, 2009.

(51) Int. Cl. G06F 19/00; G06G 7/48; G06F 17/50

(52) U.S. Cl. 702/104; 703/6

(57) ABSTRACT

A method of predicting sensor performance, such as focal plane array (FPA) behind optics casting an image based on radiant energy received from a target such as a star, planet, other celestial body, event, mass, artificial body, or the like. A user may select artificial, natural, or both types of bodies, and a dynamics module provides relative motion trajectories in space. Radiance proceeding from a target toward a sensor is modified by effects of bodies and the environment, considering any arbitrary selection of bodies and sensors, radiance effects, and relative motions therebetween, whether terrestrial or intergalactic in scale, location, or observation point. Thus, corrections and calibrations may improve images, factoring out cluttering effects of the environment and other bodies.

### RELATED APPLICATIONS

This application claims the benefit of (1) co-pending U.S. Provisional Patent Application Ser. No. 61/026,424 filed on Feb. 5, 2008 and (2) co-pending U.S. Provisional Patent Application Ser. No. 61/148,136 filed on Jan. 29, 2009, both of which are incorporated herein by reference in their entirety.

### BACKGROUND

1. The Field of the Invention

This invention relates to computer systems applied to astrophysics imaging and modeling and, more particularly, to novel systems and methods for designing, testing, and evaluating sensor systems.

2. Background

The principles of physics describe the behaviors of objects in the universe. Objects may range from sub-atomic, atomic, or molecular particles to celestial bodies and galaxies. To the extent that observations have provided laws generally accepted, behaviors of various bodies may be described by suitable equations

Meanwhile, the equations that characterize physical objects and their behavior may be manipulated by mathematics. Whether an equation from physics provides some approximation of observations or an exact equation, behaviors and performances of objects and systems may be cast in appropriate systems of equations.

Mathematics provides solutions to systems of equations. One may solve those equations to determine certain dependent variables in terms of other, known, independent variables. In general, an equation or a system of equations describing an object or system are solved by some method of exact or approximate solution in order to provide information about dependent variables not directly observable. The more equations required, the more complex and difficult the calculations for solving the system of equations. However, the more equations, independently available, the more dependent variables may be determined.

However, many systems of equations are limited in how complex the interactions available or tractable. Thus, in many circumstances, various parameters or variables may need to be fixed values. Accordingly, such variables are no longer even truly independent variables. Rather, they are fixed as constants. In astrophysics, many systems are designed using equations solved in smaller systems with many variables simply fixed at values of interest rather than being solved together in larger systems. That is, few problems warrant or permit the complexity of leaving all acting independent variables as variables. In these circumstances, certain independent variables in the equations must be fixed.

However, it would be an advance in the art to provide an astrophysical model for designing sensors that would provide a broader range of independent variables incorporated into a system of models, giving users broad and arbitrary ability to select independent variables and their operating ranges at will. The radiance behaviors of various natural and artificial bodies including satellites, vehicles, sensors on any thereof, and environments about the earth, solar system, galaxy, and so forth are so complex that they are not solved together. Rather, individual equations or small systems of equations may characterize a particular behavior of a sensor associated with a small number of bodies, such as a satellite looking at the earth or into space, by treating many characteristics of interest simply as fixed numbers.

Accordingly, it would be an advance in the art to provide a user an arbitrarily selectable array of celestial and artificial bodies along with an ability to characterize each of those bodies with respect to its body dynamics and radiance properties. It would be a further advance in the art to provide an analysis system for design of sensors to properly model the performance of an arbitrary sensor in view of the body dynamics of a large system of bodies together with their respective radiance characteristics such as material properties, radiation behaviors, atmosphere, trajectories, eclipses by other bodies, lines of sight, obstructions and the like for vehicles, satellites, celestial bodies, and environments throughout the solar system and beyond.

### BRIEF SUMMARY OF THE INVENTION

In view of the foregoing, in accordance with the invention as embodied and broadly described herein, a method and apparatus are disclosed in one embodiment of the present invention as including a computer- aided design system that integrates analysis, development, modeling, and the like of sensor-based systems. In one embodiment, an apparatus and method in accordance with the invention provides to a user a system of modules executable on a processor to describe relative motion between objects (e.g., bodies, whether natural or artificial) ranging from an interstellar or inter-galactic scale down to solar system, planetary, or vehicle scale, or a combination thereof. The problem of interest is a sensor at one location viewing one or more targets located elsewhere, all of which may be located with respect to at least one body.

The system supports arbitrary selection of a “host” from among any bodies selected, across the range of scaling. The host may be thought of as the location on which or with respect to which a target or sensor is located. The system considers radiance proceeding from a target and radiance arriving at the a sensor, as modified by radiance properties of all other bodies selected and environmental factors that may intervene. Thus apparent radiance sensed at a sensor may be adjusted to represent radiance proceeding from a target by incorporating adjustments corresponding to the extraneous effects of other bodies and the environment on the actual sensed radiance.

Software in accordance with the invention may provide a physics-based model for the systems engineering of sensor-based missions, and may also allow rapid specification of a mission scenario and analysis according to the mission specifics. Factors considered may include, for example, distances, orientations, velocities, angular rates, viewing obstructions, and the like of sensors and their observed targets. Likewise considered may be scene radiances arriving at the sensor, ranging from UV to long wave IR. The system may accomodate predicted sensor performance metrics and generated synthetic images, amenable for processing by mission image analysis algorithms.

In selected embodiments, sensors, targets, trajectories, and the like may be parametrically defined using a graphical user interface. An apparatus and method in accordance with the present invention may support, for example, proposal development, mission system engineering, sensor system engineering, operations planning, performance specifications, clutter suppression, sensor calibration, and the like.

One may think of a system in accordance with the invention as “operating” a sensor “seeing” a target, each from any point, selected by a user, in order to provide a characterization of what the sensor “sees.” For example, a view of the target's radiance, considering radiance from other influential bodies and the effects of the environment, such as scattering, absorption, emission, and the like.

In selected embodiments, a system in accordance with the invention may include a software system combining several principal analyses of subsystems into an integrated package. Thus a user may control arbitrarily, a broad range of modeling interactions of individual subsystems as well as the overall system performance.

Of course, sensor performance represents one principal subsystem. Principal subsystems may also include body kinematics or dynamics (e.g., determination of motion both natural and artificial heavenly bodies) and environmental influence (e.g., determinations such as atmospheric influence on scattering, re-radiation, absorption, and the like). Another principal subsystem is radiance (e.g., determination of radiance of all locations of interest on all bodies of interest) such as for target location areas and sensor location areas, as well as all background radiance from environment and bodies.

In certain embodiments, an apparatus and method in accordance with the invention may include a plurality of executable software modules to solve each of the foregoing analyses, their contributory components of analysis, and to solve each of them in the context of all the others. Bodies need not be restricted to earth or to space, but may include objects on the surface of the earth, satellites, extra galactic bodies, a region of space, and so forth.

An apparatus and method in accordance with the invention may include a method of predicting sensor performance and a method of sensor calibration, a method of factoring out errors, or both. Sensors may be of any suitable type, but typically may be of a type using a focal plane array (FPA). Suitable optics may cast an image onto the FPA based on radiant energy received from a target such as a star, a planet, another celestial body or phenomenon in space, an artificial body made by human endeavor on earth and located on the earth, in the atmosphere thereof, in space, or on any other celestial body.

The method may include executing a body dynamics module to provide trajectories of bodies in space. The bodies may be arbitrarily selectable by a user from any natural and artificial bodies existing. Such bodies may be selected on any scale, for example, between an inter-solar system scale and an individual object scale, such as the tactical scale corresponding to an artificial, fabricated, structure.

The method may include executing a target module to provide behavior of a target at a first location, arbitrarily selectable by a user. For example, the target may be any location arbitrarily located in space, and identifiable on, above, around, orbiting, between, or otherwise with respect to the bodies;

A radiance model determines a first radiance proceeding from the target toward a sensor located at a second location in space. Meanwhile, executing an environment module may determine a second radiance from the environment as well as the influence of the environment on the first radiance.

A sensor module may determine response of the sensor to a third radiance incoming to the sensor. The third radiance is a combination of the first radiance and a second radiance. Ultimately; the output of the method may provide a correction, data effective to correct the output of the sensor to represent (identify or report out) the first radiance based on detection of the third radiance by the sensor. Thus, images may be obtained out of the clutter of the environment and other bodies not of interest to the owners of the sensor.

The method may operate on a selected scale anywhere between a small or local proximity on the order of the size of a vehicle and an inter-solar system distance. Intergalactic distances may also be considered as the distance between a sensor and a target. Distance between a sensor and a target may involve a sensor on an earthbound vehicle such as a truck, watercraft, aircraft, the earth's surface, a buoy, a balloon, or the like observing a target at any location within the solar system. For example, a target may be on or a part of a vehicle, a celestial body inside or outside the solar system, a region of space, a nebula, a star, another galaxy, or the like. Meanwhile, a sensor may instead be attached to, a portion of, or otherwise associated with a satellite in orbit, a rocket, a planet in the solar system, or any celestial body outside the immediate solar system.

A user may arbitrarily select first and second bodies, either or both being selected from natural or artificial bodies. The bodies' locations will typically imply the scale of observation. The sensor may be defined in terms of performance parameters or by specifying a sensor of known characteristics.

A user interface provides access to an input module receiving inputs from a user who may select control parameters specifying the bodies to be modeled and radiance corresponding to each. Radiance effects on self are also considered for bodies. Particularly for a sensor on a satellite or earthbound vehicle, the satellite or other vehicle may itself affect performance by radiating energy to the sensor. Any manmade structures, whether moving or stationary, whether on the surface of a planet or above it, whether on terra firma or water, may all be considered as targets or platforms for sensors.

Typically, by selecting locations and operating parameters for a sensor platform, a sensor, and a target, a user may operate the system to control the position and orientation of each of the locations of interest. The system determines the dynamics or kinematics describing motion of all the natural and artificial bodies selected, then models radiance originating from each as well as the environment. The system may model any or all interactions affecting emission, transmission, reflection, absorption, re-radiation, shadowing or eclipsing, and the like affecting radiation arriving at a sensor based on that proceeding from a targets. For example, modeling environmental influences on radiance may consider atmospheric influence on scattering, absorption, reflection, transmittance, and re-radiation as it affects radiance ultimately arriving at a sensor.

A body dynamics module may provide paths, orbits or other trajectories of the bodies in space. Typically, each body may be placed in a hierarchy such that each bodies' motion occurs with respect to its root (e.g., the body around which it orbits, on which it travels, etc.). Thus a hierarchy may be established to define motion of a each body with respect to another until the base root established as the reference point from which all motion may be determined relative thereto. Thus the bodies may be being arbitrarily selected so long as they may be placed in a hierarchy of relative motion.

A target module may provide specification of behavior of a target comprising a first location, arbitrarily selectable by the user, arbitrarily located in space, and identifiable with respect to the bodies. Thus the target may be a surface region, a center, a region of space identifiable at a distance from a body, or the like. A radiance module may determining radiance proceeding from the target toward the sensor located elsewhere, on the same body, on another body, or anywhere that can be identified as a location in space, whether or not fixed to a body or otherwise bound thereto.

An environment module may determine radiance attributed to the environment, as well as the influence of the environment on radiance originating elsewhere and directed toward a sensor of interest. Thus, a sensor module may determine response of the sensor to radiance incoming to the sensor, comprising radiance proceeding from a target, together with radiance proceeding from all other bodies in the system being analyzed, and radiance effects from the environment, whether originating radiance, redirecting it, or attenuating it.

The system may thus provide correction data effective to correct the nominal output of a sensor to represent the actual radiance from a target, based on detection of actual radiance arriving corrected for the radiance effects thereon by all other extraneous actors (e.g., bodies environment, and so forth) considered by the system.

A system in accordance with the invention may be embodied in a computer-readable medium storing modules executable on a processor to determine radiance response of a sensor. The sensor may be specified at any sensor location that may be defined with respect to a body. Modules programmed to execute on a processor may include, for example, an input module to receive inputs specified by a user, a user interface operably connecting to the input module and receiving inputs from the user as the user selects control parameters specifying bodies and radiance corresponding to each. A database module or database receiving, storing, and retrieving parameters to specify bodies selected from natural and artificial bodies may organize records in any suitable architecture to maintain data.

Data may define celestial bodies found in nature (e.g., astronomical in nature), stationary, manmade structures on a planet; movable, manmade vehicles on the surface of a planet, manmade aircraft flying within the atmosphere of a planet, manmade satellites in orbit around any body, or the like. Data may define targets comprising locations selected by the user from any definable space on or between the selected bodies in the system. Sensors may be defined in the database for use by the sensor module as devices at arbitrary locations, and operational parameters specified by the user.

A kinematics or dynamics module may describe motion of the bodies to determine the positions and orientations of the targets and sensors. A Radiance module may determine radiance proceeding from and arriving at the bodies, and may optionally be tasked to incorporate the results from target modules, and sensor modules do the same for targets and sensors, respectively. Alternatively, a separate controller or integration function may be the executable module to incorporate results from all three and the environmental module.

An environmental module may determine influences of the environment on radiance, comprising determining atmospheric influence on scattering, absorption, reflection, transmittance, and re-radiation at the regions or locations of interest, typically along the path from a body to the sensor. The sensor module may determine performance of one or more sensors in detecting (e.g., imaging) radiance arriving at one or more sensor. The analysis may provide factors for calibration, backing out error to determine radiance actually proceeding, from the target, or both

### BRIEF DESCRIPTION OF THE DRAWINGS

The foregoing and other objects and features of the present invention will become more fully apparent from the following description, taken in conjunction with the accompanying drawings. Understanding that the drawings depict only typical embodiments of the invention and are, therefore, not to be considered limiting of the invention's scope, the invention will be described with additional specificity and detail through use of the accompanying drawings in which similar items may have the same number, name, or both. The illustrated embodiments of the invention will be best understood by reference to the Figures and accompanying text in which:

FIG. 1 is a schematic block diagram of one embodiment of an apparatus and method suitable for implementing the system of the invention in computer hardware on a single computer or over a network or internet work;

FIG. 2 is a schematic block diagram of one embodiment of the modular architecture of an apparatus and method in accordance with the invention, as held in computer readable memory;

FIG. 3 is a schematic block diagram of the hierarchy of bodies arranged with respect to their motion relative to one another;

FIG. 4 is a schematic block diagram of one embodiment of a process in accordance with the invention;

FIG. 5 is a screen view of an input menu screen corresponding to celestial bodies;

FIG. 6 is a screen view of an input menu screen corresponding to satellites;

FIG. 7 is a screen view of an input menu screen corresponding to vehicles;

FIG. 8 is a screen view of an input menu screen corresponding to targets;

FIG. 9 is a screen view of an input menu screen corresponding to sensors;

FIG. 10 is a screen image of a window for user selection of time parameters for implementing a radiants analysis in accordance with the invention;

FIG. 11 is a screen image of a window for user specification of parameters characterizing the earth;

FIG. 12 is a screen image of a window for user specification of parameters characterizing the sensor satellite;

FIG. 13 is a screen image of a window for user specification of parameters characterizing a vehicle of a ground-based type;

FIG. 14 is a screen image of a window for user specification of parameters characterizing a vehicle of an airborne type;

FIG. 15 is a screen image of a window for user specification of parameters characterizing a sensor;

FIG. 16 is a screen image of a window for user specification of parameters characterizing a target;

FIG. 17 is a screen image of a menu for selection by a user of a system of units in which to present information for and from an analysis of a sensor system, in accordance with the invention;

FIG. 18 is a screen image of the input display showing a synthetically generated image corresponding to a sensor's field of view; and

FIG. 19 is a screen image of an output display showing the parametrically defined pixelation of the sensors and optical diffraction effects and noise sources corresponding to sensor performance.

### DETAILED DESCRIPTION

It will be readily understood that the components of the present invention, as generally described and illustrated in the specification, could be arranged and designed in a wide variety of different configurations. Thus, the following more detailed description of the embodiments of the system and method of the present invention, is not intended to limit the scope of the invention, but is merely representative of various embodiments of apparatus and methods in accordance with the invention.

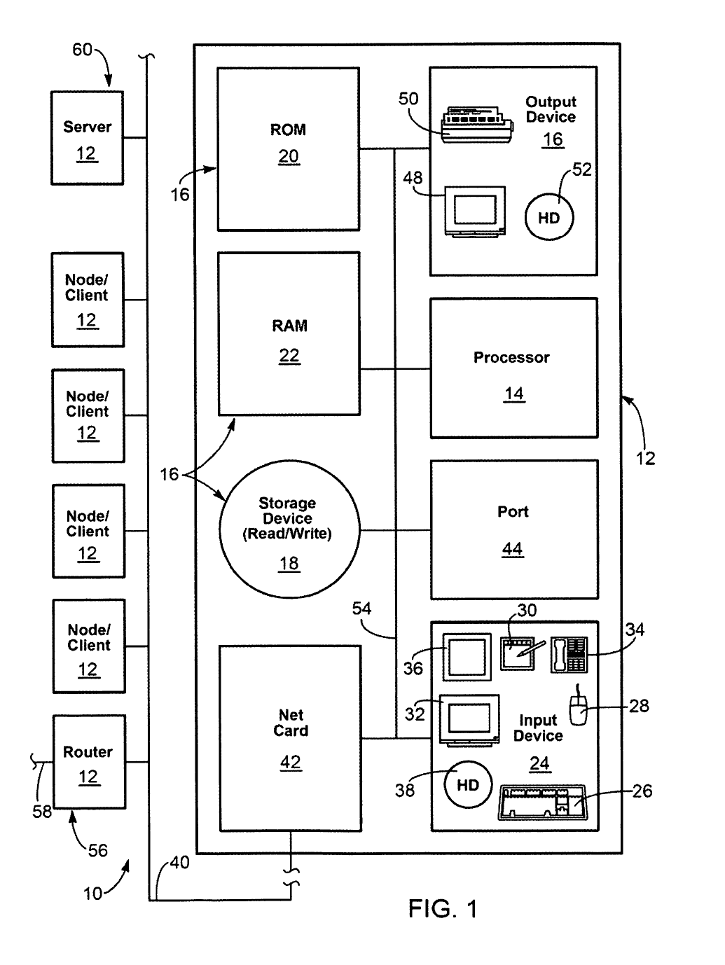

Referring to FIG. 1, an apparatus 10 or system 10 for implementing the present invention may include one or more nodes 12 (e.g., client 12, computer 12). Such nodes 12 may contain a processor 14 or CPU 14. The CPU 14 may be operably connected to a memory device 16. A memory device 16 may include one or more devices such as a hard drive 18 or other non-volatile storage device 18, a read-only memory 20 (ROM 20), and a random access (and usually volatile) memory 22 (RAM 22 or operational memory 22). Such components 14, 16, 18, 20, 22 may exist in a single node 12 or may exist in multiple nodes 12 remote from one another.

In selected embodiments, the apparatus 10 may include an input device 24 for receiving inputs from a user or from another device. Input devices 24 may include one or more physical embodiments. For example, a keyboard 26 may be used for interaction with the user, as may a mouse 28 or stylus pad 30. A touch screen 32, telephone 34, or telecommunications line 34, may be used for communication with other devices, with a user, or the like. Similarly, a scanner 36 may be used to receive graphical inputs, which may or may not be translated to other formats. A hard drive 38 or other memory device 38 may be used as an input device whether resident within the particular node 12 or some other node 12 connected by a network 40. In selected embodiments, a network card 42 (interface card) or port 44 may be provided within a node 12 to facilitate communication through such a network 40.

In certain embodiments, an output device 46 may be provided within a node 12, or accessible within the apparatus 10. Output devices 46 may include one or more physical hardware units. For example, in general, a port 44 may be used to accept inputs into and send outputs from the node 12. Nevertheless, a monitor 48 may provide outputs to a user for feedback during a process, or for assisting two-way communication between the processor 14 and a user. A printer 50, a hard drive 52, or other device may be used for outputting information as output devices 46.

Internally, a bus 54, or plurality of buses 54, may operably interconnect the processor 14, memory devices 16, input devices 24, output devices 46, network card 42, and port 44. The bus 54 may be thought of as a data carrier. As such, the bus 54 may be embodied in numerous configurations. Wire, fiber optic line, wireless electromagnetic communications by visible light, infrared, and radio frequencies may likewise be implemented as appropriate for the bus 54 and the network 40.

In general, a network 40 to which a node 12 connects may, in turn, be connected through a router 56 to another network 58. In general, nodes 12 may be on the same network 40, adjoining networks (i.e., network 40 and neighboring network 58), or may be separated by multiple routers 56 and multiple networks as individual nodes 12 on an internetwork. The individual nodes 12 may have various communication capabilities. In certain embodiments, a minimum of logical capability may be available in any node 12. For example, each node 12 may contain a processor 14 with more or less of the other components described hereinabove.

A network 40 may include one or more servers 60. Servers 60 may be used to manage, store, communicate, transfer, access, update, and the like, any practical number of files, databases, or the like for other nodes 12 on a network 40. Typically, a server 60 may be accessed by all nodes 12 on a network 40. Nevertheless, other special functions, including communications, applications, directory services, and the like, may be implemented by an individual server 60 or multiple servers 60.

In general, a node 12 may need to communicate over a network 40 with a server 60, a router 56, or other nodes 12. Similarly, a node 12 may need to communicate over another neighboring network 58 in an internetwork connection with some remote node 12. Likewise, individual components may need to communicate data with one another. A communication link may exist, in general, between any pair of devices.

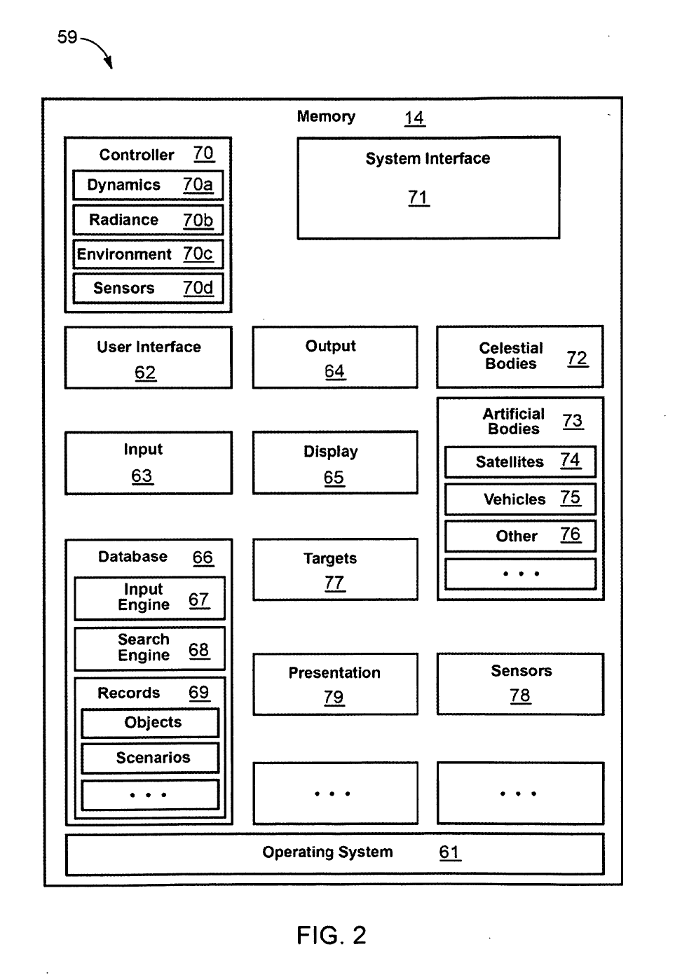

Referring to FIG. 2, a memory device 14 associated with a processor 12 or multiple processors 12 a computer 10 or system of computers 10 may host various modules. For example, stored in computer readable memory 14, and capable of execution by a processor 12, may be an operating system 61 (O/S 61). The O/S provides to the system 59 the required access to the processing capability of the processor 12. Thus the modules run “on top of” the O/S 61 for evaluating and designing performance of sensors in a system of artificial and celestial bodies operating on a planet, within a solar system, between galaxies, or the like.

In one embodiment, a user interface 62 may operate to provide screens, menus, buttons, and the like enabling a user to control the system 59. One principal focus of the user interface 62 is the presentation of information to a user and the receipt of command and control parameters reflecting the desires and decisions of the user. To that end, an input module 63 may process inputs and the presentation of screens, buttons, dialog boxes, key strokes, and the like for receiving inputs to control the system 59.

Likewise, an output module 64 may provide outputs to the user interface for viewing, export, transfer, imaging, storing, or other manipulation of outputs in order to be most useful to the purposes of the user.

A display module 65 may control the administration of displays to a user. For example, displays may include visual, audio, graphical, or any other display mode sensible by a user and reflecting information desired to be output through the user interface 62. In some embodiments, a user interface 62 may be used primarily by a user to set up the input and output of information. Alternatively, The actual input and output processes may be done entirely automatically by other computers, devices, or systems. Nevertheless, in certain embodiments, the user interface 62 may be a graphical interface presenting information in a clear and consolidated form readily interpreted, specified, manipulated, and the like by a user as desired.

In certain embodiments, a database 66 may obtain, hold, and retrieve information for use by the system 59. For example, data files describing any particular object of interest (e.g., natural or artificial body, sensor, target) may be stored in the database 66. Likewise, files of inputs by a user may be stored. Meanwhile, files reflecting the output of the system 59 in operation may be stored for future display, transfer, comparison, and the like.

Similarly, various data common to many analyses, such as the physical parameters reflecting the orbits, radiance characteristics, and the like of planets, stars, the sun, moons. satellites, other manmade objects, and so forth may also be stored in the database 66. The database 66 may include an input engine 67 as well as a search engine 68 for creating and retrieving, respectively, the records 69.

Records 69 may be associated with users, scenarios, objects such as celestial bodies and artificial or manmade bodies, regions of space, target or target locations associated with any particular body, parameters characterizing a sensor, or the like. Records may be stored in any suitable format. For example, object orientated programming may be used to establish software objects having attributes reflecting data parameters of the physical objects of the system, along with executables for using that data to manipulate and calculate as needed.

A controller 70 may be thought of as the central portion of a system 59. Coordinating the dynamics modeling is the dynamics module 70a, determining the body dynamics and kinematics of any objects (bodies) of interest. Objects or bodies may range from a small target object such as a vehicle on a surface or in the atmosphere of a particular celestial body to a satellite orbiting a body or passing through space, to any particular celestial body of the solar system, the galaxy, or the like.

Ultimately, it may be useful to accommodate radiance originating or proceeding from any body or from any space. Accordingly, the body dynamics control module 70a provides for determining the relative motions, spatial relations, lines of sight, shadowing, exposure, and the like of one body or a region of space with respect to another.

Meanwhile, the radiance model 70b may be thought of as modeling the radiance of bodies, while the environmental effects thereon may be modeled by the environment module 70c. The radiance control module 70b within the controller 70 may control the modeling of the radiance parameters of any targets, satellites, celestial bodies, other artificial bodies, or the like of interest. Meanwhile, the radiance model 70b may be responsible to cooperate with or may even incorporate the environment module 70c.

Objects, materials, or influences within an environment may absorb, reflect, scatter, transmit, emit, re-radiate, and the like radiation or radiant energy, referred to herein as radiance. Accordingly, a radiance control model 70b may be thought of as responsible to coordinate determination of the radiance performance of any objects of interest, and may coordinate with, control, incorporate, or otherwise interact with the environment control module 70c responsible for handling both the effect on radiance by an environment.

The sensors module 70 or sensors control module 70d may be responsible for modeling, calculating, and otherwise determining the performance of sensors tasked with detecting (e.g., imaging, tracking, distinguishing) targets. Targets may be portions of any particular body, region of space, or the like. Accordingly, a sensor exists to detect, image, or otherwise provide information about a target in space. Thus, a sensor control module 70d may be responsible to determine that performance as a sensor may receive radiance from an object or a region in space, which radiance may be affected by environmental factors. Ultimately the module 70d will control determination of the response by a sensor to the radiance as emitted by a body and modified by the environment.

Thus, a controller 70 may operate to integrate the effects of the participating bodies, targets, sensors, and the like being used in a design, simulation, analysis, or the like. It may have subcomponents 70a, 70b, 70c, 70d to accomplish individual portions of the overall objective.

In general, an apparatus and method in accordance with the invention may include a system interface 71. For example, a user may determine to run various models of sensors. Accordingly, a system interface 71 may support a user to specify certain files, records, and the like to be input through the input module 67, as specified via the user interface 62. Inputs need not all be by actual key punch or manual entry by a user. Another computer program may operate as a user to drive an application in accordance with the invention. Thus, that outside application may provide through the system interface 71 all or some of the inputs of a user.

Also, the user interface 62 may interact with the input system 63 to invoke the system interface 71 for designating files or other imported data as inputs. Similarly, the system interface 71 may be invoked through the user interface 62 and the output module 64 to output files, images, and the like to electronic media or the like.

A celestial bodies module 72 may support the calculation, specification, or both of the parameters defining celestial bodies and their behavior. Celestial bodies may also be referred to as “natural bodies” whether asteroids, moons, planets, suns, galaxies, and so forth. The celestial bodies module 72 is responsible for the calculation, specification, or both of information defining celestial bodies and their behavior in the system 59. The artificial bodies module 73 may be responsible for the calculation, specification, or both of information defining all manmade objects or artificial objects and their behavior. For example, a satellite module 74 may be responsible for the calculation, specification, or both of information defining one or more satellites and their behaviors.

Similarly, a vehicles module 75 may be responsible for the calculation, specification, or both of information defining vehicles and their behavior in the system. Vehicles may include earthbound vehicles such as truck, cars, trains, and the like as well as water craft including ships, boats, and the like, aircraft such as airplanes and balloons, and the like. Other modules 76 may accommodate other structures of interest. For example, certain bodies may be immovable buildings. Likewise, a body may be defined in terms of any parameters that will accommodate its location, any movement, and radiance parameters.

The contributing portions of the artificial bodies module 73 may be used for the calculation, specification, or both information defining bodies and their behavior. They may interface with the database 66 to obtain or create data in the records thereof. The artificial bodies module 73 may simply rely on the database 66 to maintain data, or may store, generate, or both certain data as a matter of convenience or efficiency. In one embodiment, the artificial bodies module 73 is responsible for executables that define and analyze the performance of all artificial bodies. In order to accomplish this responsibility the artificial bodies module 73 may have hard coded parameters and data, may rely on the database 66, or may use some combination of both. To the extent that information can by cataloged and store in the database 66, the artificial bodies modules 73 may be more arbitrarily invoked at will to simply operate on data obtained from the records 69 of the database 66.

Just as the celestial bodies module 72 and the artificial bodies module 73 define the location and radiance characteristics, respectively, of objects, the sensors module 78 be responsible for the calculation, specification, or both of sensors. Of course, sensors' internal operational parameters may characterize the focal plane array, optics, signal processing, and the like.

In certain embodiments, a presentation module 79 may provide information controlling the nature of presentation of information to a user. For example, the presentation module 79 may control the type of units used, the coordinate system to be used, a color scheme, color transformations, and forms of outputs such as images, graphs, numbers, and so forth by which the display module 65 will present information to a user for input or output purposes.

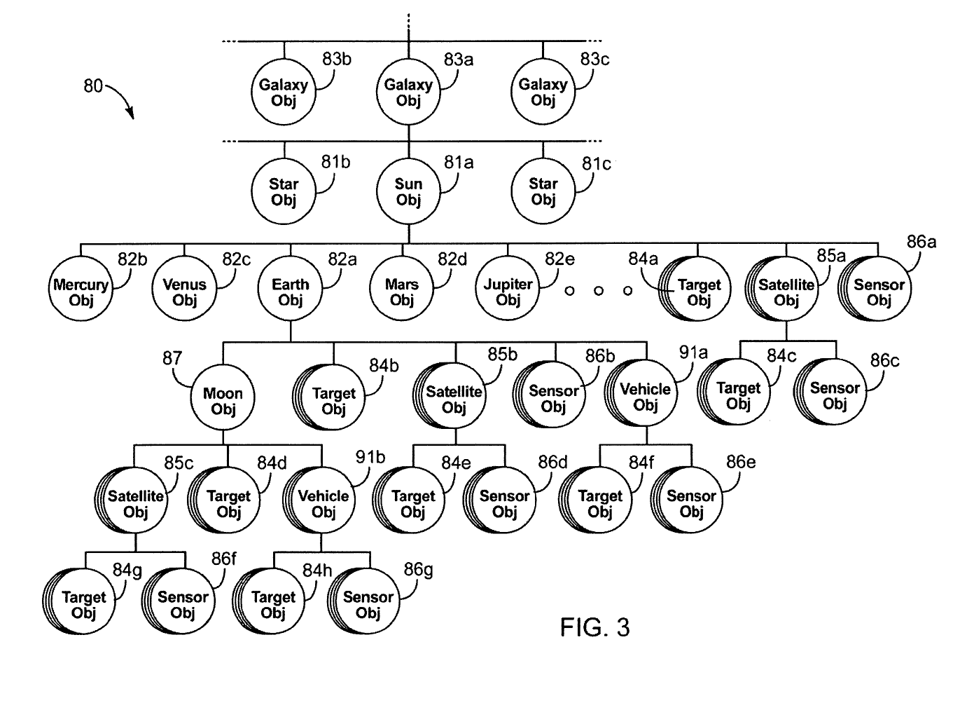

Referring to FIG. 3, a hierarchy 80 of bodies may correspond to relative positions and velocity therebetween. For example, any particular body may be used as a base or root body for reference. Thus, in a mathematical sense that body's motion is treated as a zero point. Thereafter, each body moving with respect to that body may be analyzed by the celestial bodies module 72 or artificial bodies module 73. Each body may be evaluated with respect to some body about which or with respect to which its own motion may be described or is otherwise known.

The reference body may also be evaluated in terms of its motion with respect to some other body about which or with respect to which its motion is known. Thus, motion may be determined all the way back to a root, base, or reference body as the zero point or reference point for all motion. In this regard, it may be often be useful to rely on the sun object 81a as a reference. With respect to the sun object 81a, the various planet objects 82 move in relative motion. Accordingly, an earth object 82a has relative motion in an orbit about the sun object 81a.

The hierarchy 80 may reflect both the physical objects and their parameterization within the system defined by those physical objects. For example, the earth object 82a may be used to represent a programming object, or a set of parameters in the database 66 defining the parameters of the earth. Likewise, the system 59 may include a Mercury object 82b, Venus object 82c, Mars object 82d, Jupiter object 82e, and so forth. Similarly, the sun object 81a may be accommodated in its motion relative to a galaxy object 83a. Of course other galaxy objects 83b, 83c, and so forth may have a relationship to our galaxy object 83a. Similarly, within the galaxy object 83a may be contained star objects 81b, 81c (with their planet objects and so forth) in addition to the sun object 81 of our solar system. Thus, all as stars may have relative motion with respect to the galaxy object 83a, and their own radiance parameters as well.

In addition to planet objects 82 having relative motion with respect to the sun object 81a, various target objects 84a, satellite objects 85a, and sensor objects 86a may correspond to targets, satellites, and sensors, respectively, having a relationship directly with the sun as represented by the sun object 81a.

At each level of the hierarchy 80, any bodies moving with respect to any other body may be defined relative to that other body. By way of example, the moon object 87 has an orbital relationship with the earth object 82a, as observed by the moon's orbit about the earth. Similarly, moving with respect to the earth object 82a may be other target objects 84b, satellite objects 85b, sensor objects 86b, vehicle objects 91a, and the like.

Multiple objects and their motion may be defined with respect to any particular object with which they have a relationship. For example, target objects 84c and sensor objects 86c may be associated, fixed to, or otherwise constrained with respect to a satellite as represented by the satellite object 85a. Thus, hierarchically, they pertain to the satellite object 85a.

Pursuing the hierarchy 80 further the moon object may have satellite objects 85c representing satellites orbiting therearound. Similarly, target objects 84d may have a relationship with the moon, either by orbiting around it, by being located on its surface, or by representing a region of space that can be defined in terms of location with respect to the moon as defined by the moon object 87.

Likewise, a vehicle object 91b may operate on the surface of the moon as defined by the moon object 87, or in some other defined relationship therewith. Continuing with the hierarchy, the vehicle object may have target objects 84h and sensor objects 86g associated with it (e.g., on it, as part of it). Similarly, the satellite object 85c may have target objects 84g and sensor objects 86f associated with it. Associations may be fixed mountings between objects, tethered relationships, orbiting relationships, or any other definable relationship.

Of course all objects may have radiance characteristics as well as physical locations and motion to be defined by their respective modules in the system. Data for the hierarchy 80 may be contained in the database 66. Alternatively, the information for the hierarchy 80 may be hard-coded or stored in any other storage manner for retrieval.

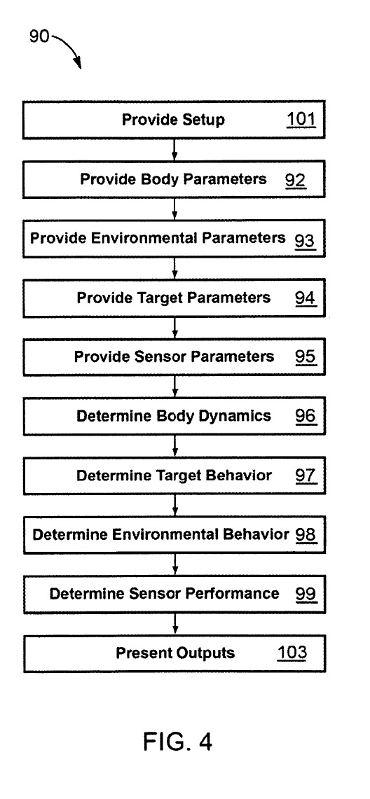

Referring to FIG. 4, the system 59 of software modules may execute in order to accomplish the process 90 in accordance with the invention. Providing 101 a setup may involve accumulating inputs as designated by a user through the user interface 62, whether or not those inputs are individually input or automatically generated by files stored in the database or elsewhere. Typically, providing 101 a setup may involve selecting the nature, the type, or the specific ones of all celestial bodies, artificial bodies, sensors, targets, and the like.

Accordingly, providing 92 the body parameters may provide both kinematic or dynamic parameters of position and motion for each body selected. Similarly, providing 93 environmental parameters may involve defining and loading (by a user or in accordance with selections of a user) environmental factors to be considered by the analysis or modeling of the system 59.

Likewise, providing 94 target parameters may typically involve operation by the system 59 to generate, populate, or otherwise provide 94 the location, motion, relative motion, or other parameters for any target or target area to be observed by a sensor in the operation of the system 59.

Providing 95 sensor parameters may involve any and all of the parameters characterizing all or any portion of a sensor and its operation to detect, image, or otherwise acquire information about a target. Included in the parameters provided 95 for sensors may be the physical location, mechanical relationships, dynamic operation or relationship with other bodies, and the radiant energy responses to various images, intensities, and spectra received. Optics and other factors, ranging from the face of the optical inputs to the back end of the signal processing may be included in the sensor parameters provided 95.

Once the system 59 has been provided 101 with setup information implemented or loaded by the steps 92-95 the system 59 may process the information to determine 96 the body dynamics of all objects. In accordance with the hierarchy of FIG. 3, the dynamics of each object may be determined with respect to or relative to any other body or object that constrains or otherwise defines its relative motion with respect thereto. Ultimately, after determining 96 the body dynamics of every object or body of interest, with respect to its reference body, the entire hierarchy will be defined, and its motion will be defined with respect to some root object (reference object) or reference point.

Target behavior may be determined 97 according to the type of target. Typically, a target will be a portion of a surface of a body, a point on a body, or a location in space defined with respect to a body. Determining 97 the target behavior may include not only body location, and therefore motion of the target in space, but also the radiant behavior of the target.

Determining 98 the environment behavior may include the operation of any characteristic that will effect radiance originating from, passing through, or attenuated by an environment or condition. For example, atmospheric conditions often scatter, reflect, absorb, or generate radiance, thus attenuating, increasing, or distributing radiant energy that otherwise would proceed from a target toward a sensor. Likewise, bodies not of interest, that is, not having a direct relationship or relative relationship of interest with a body hosting a sensor may still have radiant influences. For example, they may originate or emit radiance, shade a particular body from radiance, or the like. Accordingly, the environmental behaviors of all environmental factors considered by the system 59 may be determined 98 in order to determine their influence on the radiance received by a sensor.

Ultimately, determining 99 the sensor performance of a particular sensor may involve analysis of the optics, focal plane array, signal processing, and the like. Such analysis may determine the intensity, image, or the like that a sensor detects, based on the radiance proceeding from a target. Nevertheless, because of the environmental behaviors determined 98, the actual determination 99 of sensor performance may provide data to correct or calibrate a sensor.

For example, when the influence of extraneous bodies, not of interest, and environmental conditions are factored out, a relationship may be determined between the radiance impinging on a sensor, and radiance originally proceeding from a target of interest. Thus, environmental and other external and internal effects may be factored out of the apparent radiance detected by a sensor to determine 99 what the sensor performance will be, and what the target object will “look like” to the sensor in a realistic situation. Ultimately, presenting 103 outputs to a user, through a display 65, to a system interface 71 for use by other computers, or the like may support the user in specifying forms of output, storage, retrieval, further processing, or the like.

In order to implement the process 90, a system and method in accordance with the invention may maintain equations, systems of equations, and the like defining all of the radiance and motion relationships. This may involve the force relationships for a full dynamic modeling between bodies. Insofar as the system 59 receives inputs identifying bodies and their behaviors of radiance and motion, it can accommodate them. Likewise, inasmuch as the system 59 receives, stores, and provides for selection by a user the equations and systems of equations, a user may select any or all objects so defined (e.g., bodies, targets, sensors). The system may then provide one or a range of integrated, overall solutions predicting the performance of any sensor in the system viewing any target over a domain of conditions imposed on any variable or object, without requiring that specific scenario to be fixed between the sensor and the target. Accordingly, longer ranges of motion, longer periods of time, and the like may be analyzed.

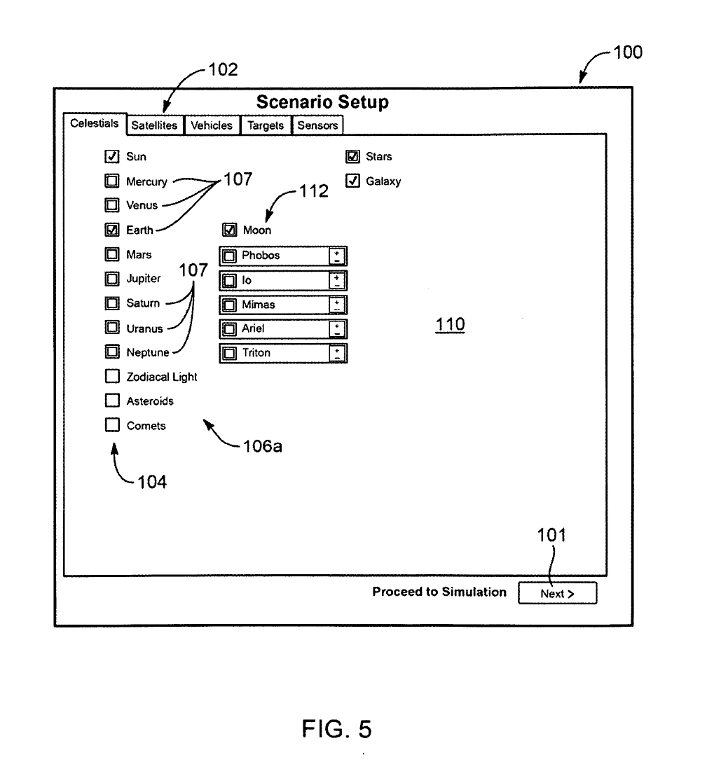

Referring to FIG. 5, one embodiment of a system 59 may be defined in terms of two primary software module families the Scenario Setup and the Simulation itself.

The Scenario Setup provides a menu 100 that allows a user (person operating the system 59, SensorCAD) to specify what objects will be included in the Simulation. It contains several sub-menus 102 (e.g., tab pages), each of which contains a collection of related sub-types 104 that may be included in the Simulation portion. When all desired objects 106 (e.g., bodies 106) have been selected for inclusion, the user pushes the Next button 108, upon which SensorCAD will proceed to the Simulation part of its operation.

The Celestials tab page 110 may allow the user to select natural objects 106a or (celestial bodies 107) from the solar system, plus the stars and Milky Way galaxy, for inclusion. If a planet is selected for inclusion, then its moons 112 may also be selected. One may proceed to exit any input page 110 by activating (e.g., clicking) the Next 101 button. The Next button 101 advances the system 10 to the next input or other operation in order.

During Simulation, any selected Celestial (celestial body 106a) may appear as part of a Sensor's generated image, may illuminate or may eclipse other objects, or may do any combination thereof according to the laws of physics.

In certain embodiments a system 59 in accordance with the invention supports a user in freely going back and forth between a scenario setup and simulation. That is, any error or missing setup activity may be readily corrected or iterated at will.

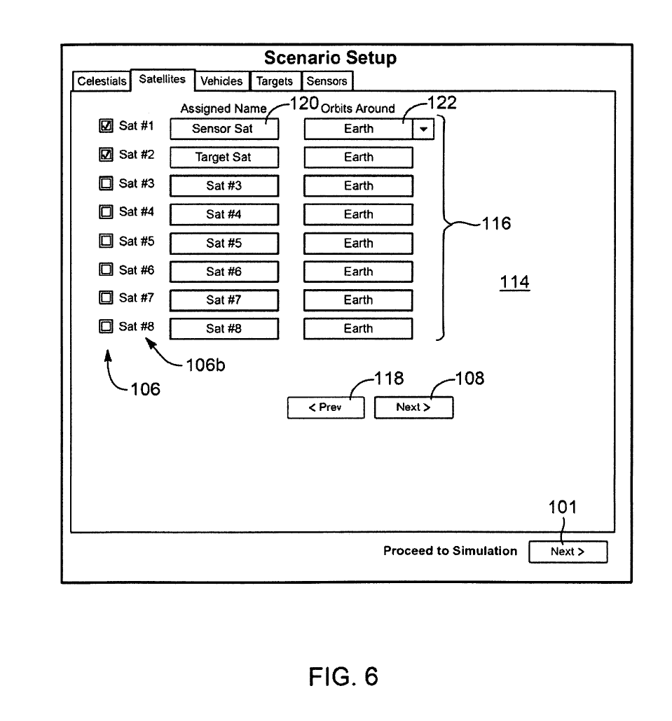

Referring to FIG. 6, the Satellites tab page 114 allows the user to select man made satellites 106a (artificial bodies 106a) for inclusion. Up to 16 independent satellites were found sufficient to be included in one particular embodiment. The selections may reside on separate Satellite selection menus 116 traversed via the Previous 118 and Next 108 buttons. A selected Satellite 120 may be specified to orbit around any of the selected Celestials. For example, a drop down menu of Celestials 107 may be invoked by right clicking the Orbits Around box 122 for the Satellite, or other user semantics and images may be used. A selected Satellite 120 may automatically assume a numeric name or may be given a name or other designation by the user for purposes of discriminating one Satellite 120 from another.

During Simulation, any selected Satellite 120 may appear as part of a Sensor's generated image, may illuminate or eclipse other objects, or do any combination thereof according to the laws of physics.

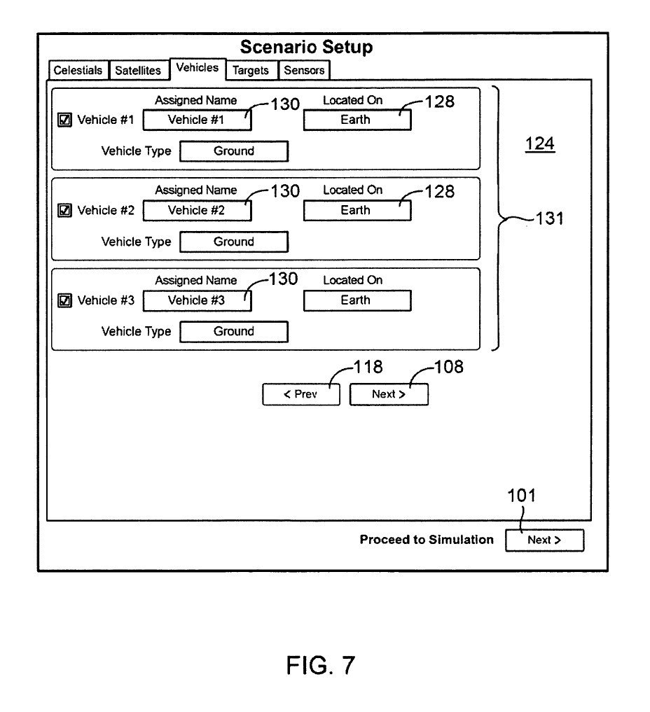

Referring to FIG. 7 the Vehicles tab page 124 allows the user to select artificial, man made vehicles 130 of any type (or any structure) for inclusion. Up to any desired number of independent Vehicles 130 may be included but half a dozen will handle most needs. The vehicle selections reside on separate Vehicles selection menus 131 that are traversed via the Previous 118 and Next 108 buttons. Selected Vehicles 130 may be specified to reside on any of the selected Celestials 107. A drop down menu of Celestials 107 may be invoked by clicking the Located On box 128 for the Vehicle. More options for user semantics or interactive images for a drop may be installed to suggest more information. For example, a shape, silhouette, or other image may replace or fill a selection box. A selected Vehicle 120 may let the more automatically assume or input a numeric name or certain designations, or may receive a name chosen by the user for purposes of discriminating one Vehicle 130 from another.

Vehicles 120 may be of any types such as ground, marine, or air, and may include other structures. Ground and marine vehicles are those constrained to travel on the surface of the Celestial 107 on which they reside. Air Vehicles may travel above the surface of the Celestial 107 on which they reside.

During Simulation, any selected Vehicles 130 may appear as part of a Sensor's generated image, may illuminate or eclipse other objects 106, or do any combination thereof, according to the laws of physics.

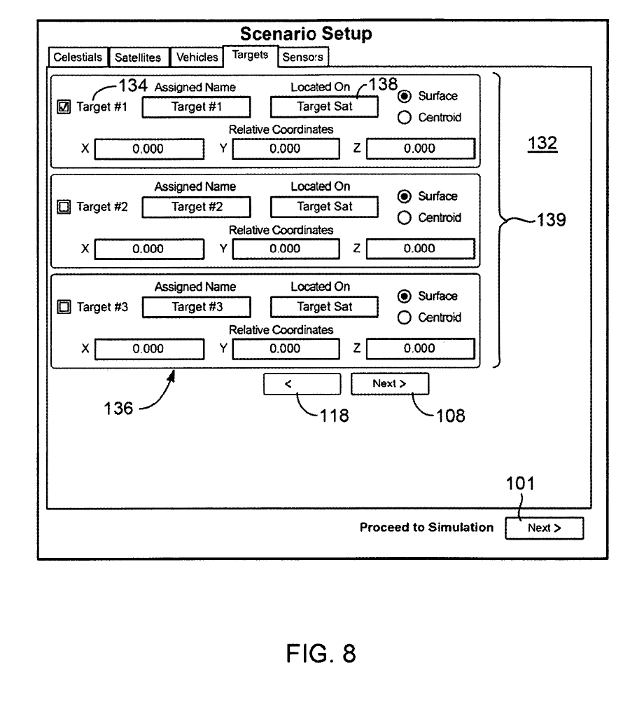

Referring to FIG. 8, the Targets tab page 132 allows the user to identify a target 134 by placing a target designator 136 or designation 136 on any previously included Celestial 107, Satellite 120, or Vehicle 130. A drop down menu of Celestials 107, Satellites 120, and Vehicles 120 may be invoked by clicking the Located On box 138 for the Target 134. Other user semantics and images may be implemented, such as image graphics or descriptive names. Several independent target designators 136 may be included. The selections may reside on separate Targets selection menus 139 traversed via the Previous 118 and Next 108 buttons. A selected target designator 136 may automatically assume a numeric name or may be given a name by the user for purposes of discriminating one target designator from another.

Target designators 136 may be specified to reside either on the surface of or at the center of an object. If that object is a Celestial 107, the surface coordinates are in terms of Longitude, Latitude, and Altitude. If the object is a Satellite or Vehicle, the surface coordinates may be in meters (or other distance units) relative to a body coordinate system (e.g., Cartesian, polar, or other) inherent to each object 106.

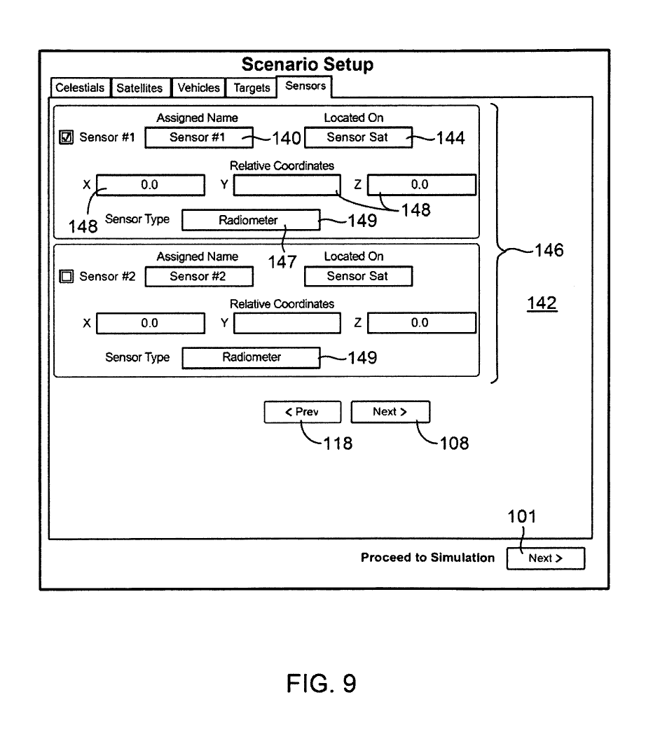

Referring to FIG. 9, during Simulation, Sensors 140 look at designated Targets 134, according to user selectable rules.

The Sensors tab page 142 allows the user to place a sensor 140 on any previously included object 106, whether on Celestial 107, Satellite 120, or Vehicle 130. A drop down menu of Celestials 107, Satellites 120, and Vehicles 130 may be invoked by clicking the Orbits Around box 144 for the Satellite 140. More options for user semantics for a drop down menu may be provided with text, graphics, more detailed parameters, or a combination thereof. Multiple independent sensors may be included. The Selections reside on separate Sensor selection menus 146 traversed via the Previous 118 and Next 108 buttons. A selected Sensor 140 may automatically assume a numeric name or may be given a name by the user for purposes of discriminating one Sensor 140 from another.

Sensors 140 may be specified to reside either on the surface of or at the center of any object 106. If that object is a Celestial 107, the coordinates 148 may be surface coordinates in terms of Longitude, Latitude, and Altitude. If the object 106 is a Satellite 120 or Vehicle 130, the coordinate 148 may be surface coordinates in meters or other distance units relative to a body Cartesian coordinate system inherent to each object 106.

Sensors 140 have a designated type 147, such as radiometer, grating spectrometer, interferometric spectrometer, radar, lidar, synthetic aperture radar, polarimeter, or the like. A drop down menu of sensor types 147 may be invoked by clicking the Sensor Type box 149 for the Sensor 140. Other user semantics, graphics or both may be used for a drop down menu. Also the sensor type selection may be associated with a channel under a particular sensor 140 or type of sensor 140.

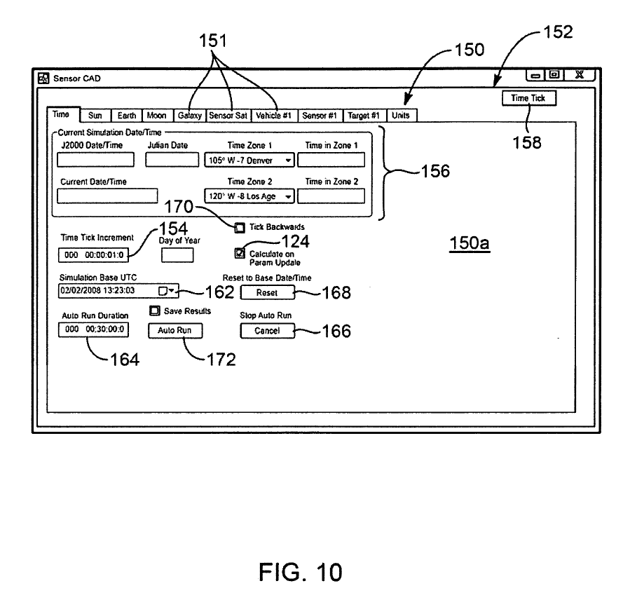

Referring to FIG. 10, another primary structure in SensorCAD is the Simulation 20 or simulation module 20. After the user elects to Proceed to the Simulation module by the Next button 101, the Simulation Menus 150 are presented by Tabs. The Simulation menus 150 allow a user to manage the Simulation module 20. The window 152 presenting these menus 150 may contain a variable number of sub-menus 150 (tab pages 150), each of which represents an object 106 selected by a user for inclusion in the Simulation 20, plus certain additional menus 150.

The menus 150 related to selected objects 106 present the physical state of the object 106 during any current stage of simulation. Various physical characteristics of manmade objects 106b may be controlled, affecting the outcome of the Simulation 20.

The Time menu 150a is one of the additional menus. It controls aspects of the simulation 20 itself, rather than the selected objects 106. Simulation 20 occurs by computing the physical state of each selected object 106 at discrete instances of time. Time proceeds from the Simulation Base Coordinated Universal Time (UTC) to a successive new time by an interval whose magnitude is determined by the “Time Tick Increment” 154. The current discrete instant of time is displayed in various formats in “Current Simulation Date/Time” 156: a civil UTC date/time, an astronomical convention known as J2000, Julian calendar date, and a civil date/time in any two world time zones.

The user can advance time manually by clicking the “Time Tick” button 158 or have time increment automatically from the Base Time 162 by successive Time Tick Increments 154, until the “Auto Run Duration” 164 has been achieved. Progression through the Auto Run 164 may be stopped at any time by clicking a Cancel button 166. After any succession of manual or automatic time advances, current Simulation time 156 may be set back to the Simulation Base UTC by clicking the “Reset to Base Date/Time” button 168.

If the “Tick Backwards” checkbox 170 is selected, the Simulation 20 proceeds backwards in time, i.e. the state of each object is calculated at successively earlier instants of time. The user may thus review the objects being simulated at some “interesting” period of time over and over and at varying time resolutions.

If the “Save Results” checkbox 172 is selected, the state of each object is saved to computer storage, for each time interval, such that other software may analyze the results of a simulation.

If the “Calculate on Param Update” checkbox 174 is selected, changing any parameter on any other menu in the Simulation structure will cause the Simulation to recalculate the state of all objects, but without changing the current Simulation time. The user may typically uncheck this box if many parameters are to be changed before the user wants to calculate a new state.

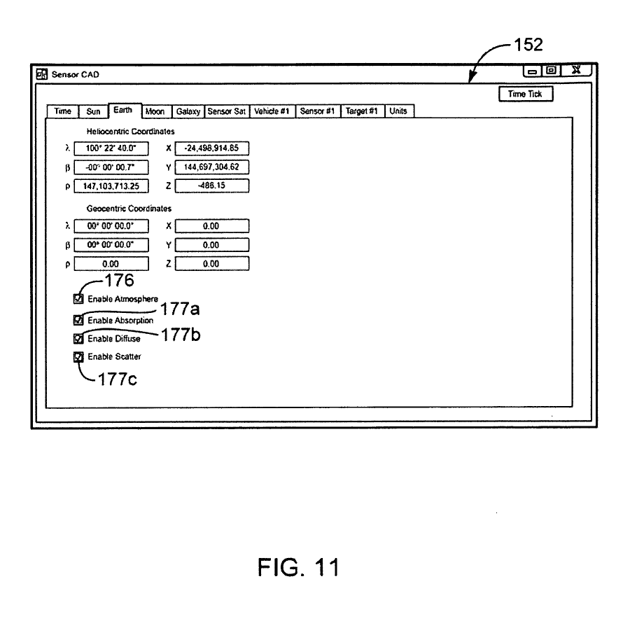

Referring to FIG. 11, celestial objects 107 may all utilize the same menu format but need not. Primarily the object location at the current Simulation time may be indicated in formats that are combinations of Heliocentric Ecliptic and Geocentric Ecliptic as the first dichotomy, and Polar coordinates and Cartesian coordinates as the second dichotomy.

During the Simulation 20, the physically correct location and orientation corresponding to the current Simulation time 156 are computed for each Celestial object 107.

The natural sizes, shapes, surface optical properties, temperatures, and emissivity of each of the Celestial objects are maintained within the Simulation 20. This allows an image of the Celestial object to be generated when viewed by a Sensor 140, or for the Celestial object 107 to provide illumination onto other objects 106 in the Simulation 20.

If the Celestial object 107 has an atmosphere, the user may select the “Enable Atmosphere” checkbox 176, depending on whether the inclusion of that atmosphere is important to the Simulation 20. Since computation of an atmosphere requires significant computer resources, the user would be expected to deselect any atmospheres that did not significantly affect the outcome, in order to speed up the Simulation.

Alternatively, Absorption 177a, Diffusion 177b, and Scatter 177c buttons may be used directly or for detailed modeling, but need not be used. Other atmospheric control parameters may be input and accessed as needed to allow the user to drive the atmosphere over ranges of conditions, such as aerosols, humidity, particulates, ozone concentration, and the like. The Simulation 20 may modulate the atmosphere over average conditions based on, for example, season, latitude, time of day, and the like.

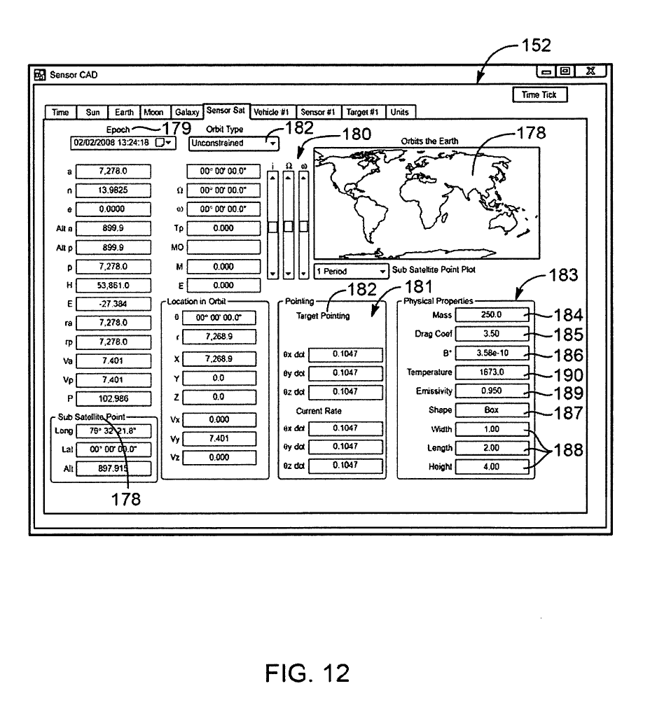

Referring to FIG. 12, satellite objects may all utilize a generalized menu format. Some major groups of menu items include orbit definition parameters, current location parameters, pointing parameters, and physical properties.

Orbits are defined by several independent parameters. The typical primary defining parameters arc: a=apoapsis, e=eccentricity, i=inclination, Ω=argument of the ascending node, and ω=argument of periapsis, Tp=time of periapsis passage, and Epoch 179. This submenu allows more than the seven inputs because alternate forms of input are possible, depending on the user's perspective of the Simulation 20. For instance, if any of a=apoapsis, n=mean motion, P=period, Alt a=altitude at apoapsis, ra=radius at apoapsis, or the like. is entered, the others may be computed. Other parameters are computed as a help in understanding the orbit, as specified, but cannot be entered by the user, such as Va=velocity at apoapsis, E=specific energy, and H=specific momentum. The user may also enter the parameters that orient the orbit in inertial space, as the Ω, ω, and i, shown via slider bars 180 as shown in FIG. 12.

Continuing to refer to FIG. 12, The Satellite's ground track 178 may be plotted on a map of the parent body. For example, the ground track 178 for one, two, or three orbital periods may be plotted. Epoch is a Date, Time, or both entered via a drop down calendar. Epoch 179 is the instant in time when the orbit defining parameters are true.

Orbit Type 182 is a drop down list that allows the user to specify whether a special orbit type (e.g., Geosynchronous, Sun Synchronous, or Molniya) or other arbitrarily defined orbits are to be entered. If one of the special orbit types is selected, the user is inhibited from entering certain parameters that are instead computed by the Simulation.

During the Simulation, the physically correct location and orientation corresponding to the current Simulation time 156 are computed for each Satellite object 120. It is possible to define orbits that collide with the parent body. This allows the “Satellite” model and module to also represent sounding rockets, ballistic missiles, and the like.

Current location parameters are shown as polar coordinates within the orbit (r=radius and θ=angle between the radius vector and periapsis), and Cartesian coordinates for location (X, Y, and Z) and velocity (Vx, Vy, and Vz), relative to parent body inertial coordinates. Additionally the Latitude and Longitude of the Sub-Satellite Point 178 (the intersection of a line joining the satellite to the parent body's center, with the surface of the parent body) and the Satellite's Altitude above that point are shown. The Sub-Satellite Point 178 is also plotted on the parent body map.

Pointing parameters 181 allow the user to specify the maximum angular velocity the Satellite may achieve around each axis in its body Cartesian coordinate frame. Also shown is the current angular velocity being demanded of each axis. If a Satellite does not have an associated Sensor 140, it will orient its Z axis to point at its parent's center. This simulates an earth-scanning satellite. If a Satellite has an associated Sensor, the Satellite's pointing is directed by the Sensor, for example, to look at Targets, target areas, scan paths, or the like. The current pointing mode 182 is indicated by a line of text such as “Target Pointing.” The demand on each Satellite axis is determined by the requirements of the current pointing mode.

Certain embodiments may allow the user to specify parameters for each axis: moments of inertia, torques, and damping, such that a control system may be modeled.

The Physical Properties parameters 183 allow the user to specify properties of the Satellite 120 that affect both the orbit and the image that a Sensor 140 observing the Satellite 120 might see. Mass 184 and Ballistic (Drag) Coefficient 185 affect the drag on the Satellite's motion if it approaches the parent body's atmosphere. B* is a value 186 computed from Mass 184 and Ballistic (Drag) Coefficient 185, commonly specified in the Two Line Element format for describing orbital parameters.

Parameters affecting images taken of the Satellite 120 by a Sensor 140 may include, for example, Shape 187, Dimensions 188, Emissivity 189, and Temperature 190. Selectable Shapes include, for example, sphere, box, cylinder, and cone. Given a Shape selection, 1 to 3 dimensions may be entered to select the size of the Satellite 120. Emissivity and Temperature are required to define images in the Infrared spectral range. The user may select from a list of typical satellite surface materials that affect the surface optical properties. These values may also be “hard coded” or data based inside the system 10.

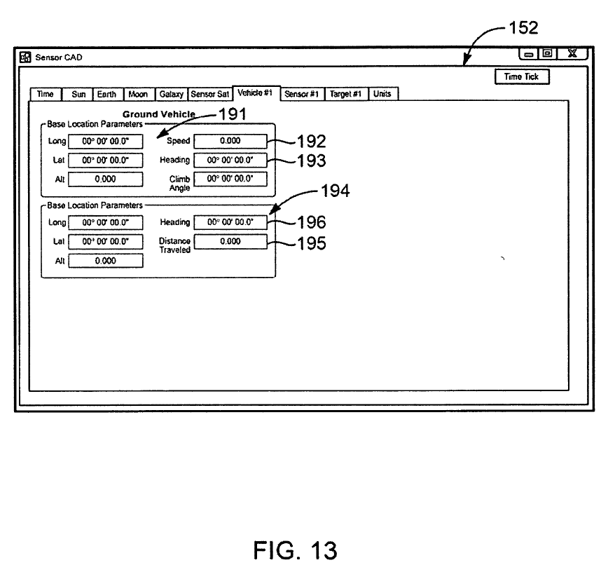

Referring to FIG. 13, Vehicle objects may all utilize the same format; however, Ground Vehicles are, by definition, constrained to remain at 0 altitude. Vehicle objects 106 have “Base Location Parameters” 191 including location expressed as a Latitude and Longitude. From this location they may proceed, for example, along a great circle route, at a specified Speed 192 along a specified initial Heading 193.

The “Current Location Parameters” 194 indicate the current location expressed, for example, as a Latitude, Longitude, and Distance Traveled 195 from the Base Location. Current Heading 196 is also indicated. Heading changes along a great circle route that does not follow either a line of Latitude or Longitude.

The orientation of Ground Vehicles is determined by the velocity vector's current direction and local vertical. Aircraft share many of the same position and velocity parameters.

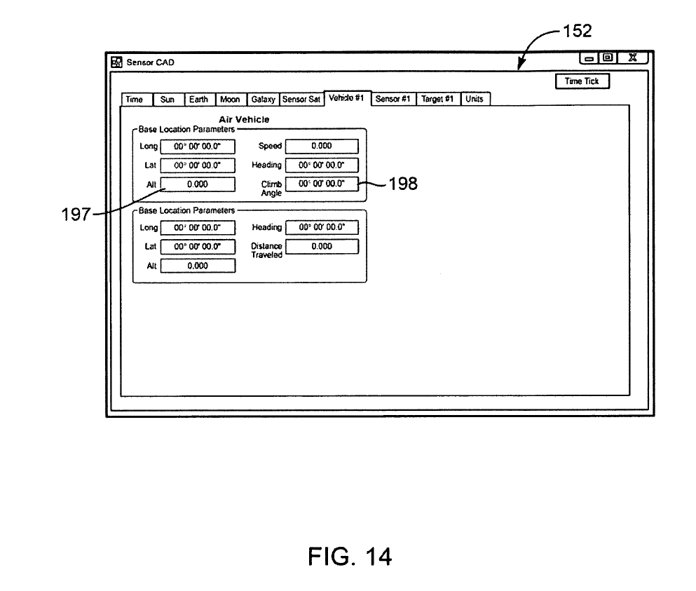

Referring to FIG. 14 Air Vehicles may have an altitude 197 other than 0, and can have a Climb (or Dive) Angle 198 such that altitude 197 changes during the Simulation 20. The orientation of Air Vehicles is determined by the velocity vector's current direction and local vertical as offset by the Climb Angle 198. Various other parameters shown are analogous to those of surface-bound vehicles.

In certain embodiments, parameters are included to control the size, shape, temperature, and surface materials of Vehicles. This is to allow the user to control aspects of the Vehicle's image that may be taken (e.g., sensed, observed, measured, or the like) by a Sensor 140.

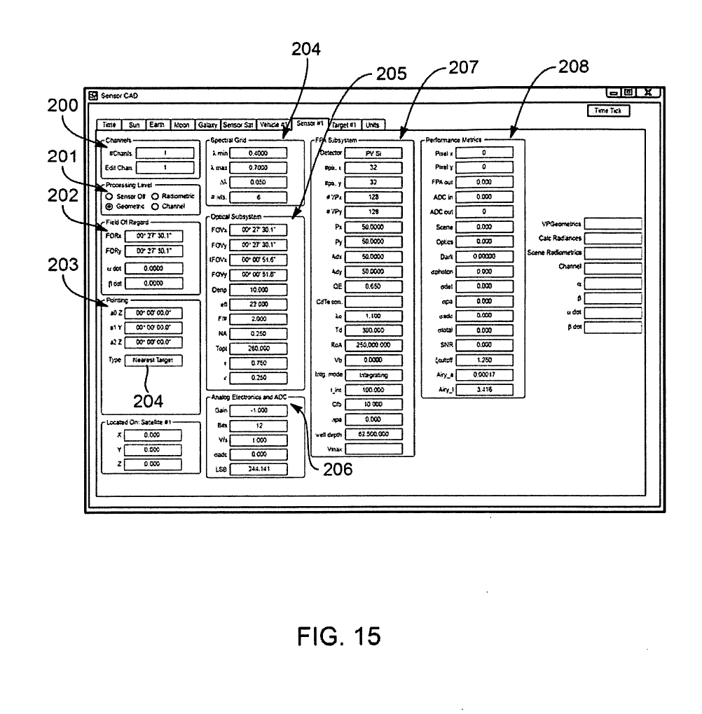

Referring to FIG. 15, Sensors 120 may utilize a general menu format in common. Parameters may be specified for Imaging Radiometer Instrument modeling Spectrometer, or the like, each having certain common and certain unique parameters to control the simulation 20 modeling.

For an Imaging Radiometer, for example, there major groups of menu items include Channels 200, Processing Level 201, Field of Regard 202, Pointing 203, Spectral Grid 204, Optical Subsystem 205, Analog Electronics and ADC 206, FPA Subsystem 207, and Performance Metrics 208.

Channels 200 (sometimes termed Bands) are different sub-instruments that share components. Typically, different focal planes generate images in different spectral regions, while sharing the more “expensive” optical components. Thus the same image may be projected onto each focal plane but in a different waveband. Different Sensor types, e.g. Imaging Radiometer and Imaging Spectrometer, can also share common optics. The presumption in this approach is that each Channel of a Sensor shares the same Line Of Sight (LOS) but may have different defining parameters. Multiple unique Channels per Sensor may be defined and the Instrument type may also be selectable per Channel, in certain embodiments.

Processing Level 201 may be implemented as a radio button selection that allows the user to enable various levels of the Sensor calculations. This exists as an operational convenience. The Sensor computations may be fairly lengthy. By only enabling as much computation as is required by the current stage of problem development, the user avoids unnecessary waiting. Off—disables all Sensor calculations. Geometric—enables computation of the geometric aspects of an image, i.e. shapes are captured without regards to brightness or waveband. Radiometric—calculates the spectral radiances of area sources and spectral irradiances of point sources. This selection computes the synthetic input image for a Sensor. Channel—the Sensor model operates on the input image and generates an output image of what the Sensor Channel would detect.

Field of Regard 202 defines the limits of Sensor pointing capabilities, if any. The user may specify the angles through which the Sensor LOS can be directed (FORx and FORy) and the slew rates (alpha dot and beta dot). An X-Y scan pointing system may also be used. Other pointing mechanisms may be useful in some embodiments. Parameters for inertia, torque, and damping on each axis in some embodiments may support more realistic pointing modeling.

Pointing 203 defines the orientation of the Sensor's 140 body coordinate system with respect to the parent object 106 on which the Sensor is mounted. By default, the Sensor's 140 body coordinates align with its parent's body coordinates. The user can provide Euler angles, A0, A1, A2, to specify a Z:Y:Z coordinate rotation of the Sensor's coordinates with respect to the defaults. Type 204 provides a drop down menu to select one of various pointing modes such as Nearest Target, Named Target, Inertial, Push Broom, or Whisk Broom.

Nearest Target directs the Sensor LOS to the closest, non-eclipsed Target. Named Target directs the Sensor LOS to the closest, non-eclipsed Target that is member of a user designated subset of the Targets. Inertial directs the Sensor LOS to a user designated astronomical Right Ascension and Declination. Push Broom directs the Sensor LOS to point in the Nadir direction with user designated angular offsets in the along-track and cross-track directions. This is a useful pointing mode for earth environmental satellites. Whisk Broom is like Push Broom, but in addition, the LOS sweeps back and forth in the cross-track direction with a user designated period.

If the Sensor 140 is mounted on a Satellite 120, the Sensor 140 conveys pointing mode and directions to the Satellite 120. The Satellite 120 completes as much of the pointing demand as its specified performance allows. If the Satellite 120 cannot achieve all that was demanded, the Sensor 140 will attempt to complete as much of the residual pointing as its specified performance allows. If the net defined pointing capability is insufficient, the target cannot be acquired or tracked. If the defined pointing capability is sufficient, the Target will be maintained centered on the LOS. If the Sensor is mounted on a Vehicle 126 or Celestial 107, the Sensor 140 must perform all pointing itself, provided that the user has specified any Sensor pointing capability.

The Spectral Grid module 204 defines the spectral bandpass λ minimum through λ maximum and the spectral interval Δλ. The number of spectral intervals is calculated. More spectral intervals allow a more accurate calculation of the Sensor's performance but increase the computation time. For example, the range of λ's may be selected from is 0.28 μm through 28.0 μm.

The Optical Subsystem module 205 defines the image forming part of the Sensor 140. It may be modeled as an equivalent single lens system. The user may specify Den, the diameter of the Optical Subsystem entrance pupil and Efl, its Effective focal length. From these the Optical Subsystem F/#—F/number and NA—Numerical Aperture are computed. The user may also specify τ, the net transmittance of the Optical Subsystem, which quantifies the absorption and reflection losses and ε, which specifies the emittance of the Optical Subsystem.

The user may specify Topt, which is the temperature of the Optical Subsystem. For Infrared Instruments, black body radiation from the Optical Subsystem creates noise in the image, requiring attention to the ε and Topt parameters to minimize this deleterious effect. In combination with the number of pixels and the pixel pitch, the FOVx and FOVy (full Field Of View in the focal plane relative horizontal and vertical dimensions) are computed. Likewise, the IFOVx and IFOVy (pixel Instantaneous Field Of View in the relative horizontal and vertical dimensions) are computed.

The FPA Subsystem module 207 defines the transducer component for converting image photons to electrons.

The Detector defines the active detector material from a drop down list, showing, for example, PhotoVoltaic (PV) Silicon, PV InSb, and PV HgCdTe. PV InGaAs, PhotoConductive (PC) As:Si, PC HgCdTe, and VOx Bolometer may be included. The user may specify a detector material appropriate to the selected spectral bandpass. Some of the following input parameters may be assigned default values by the model, based on detector material selection, but may be overridden by the user.

The variables # pix. X and # pix. Y are the number of detector pixels in the Sensor relative horizontal and vertical directions. Variables, # VPx and # VPy are the computed number of “Virtual Pixels” in the Sensor relative horizontal and vertical directions. To correctly represent the analog world digitally, the synthesized input image may be computed at a higher (Nyquist) spatial frequency as determined by the Sensor's pixel spacing and image diffraction. Variables # VPx and #VPy indicate this required frequency.

Variables Px and Py are the pixel pitch (dimensions) in the Sensor relative horizontal and vertical directions. Variables Adx and Ady are the active area of the pixels in the Sensor relative horizontal and vertical directions. QE is the quantum efficiency of the detector. Variable CdTe con., if the HgCdTe Detector Material is selected, allows the user to select CdTe doping concentration to adjust the wavelength response.

Variable (i.e., parameter) λc is the cutoff wavelength of the Detector Material. Parameter Td is the detector temperature. Variable RoA is the detector Resistance/Area product. Variable Vb is the detector bias voltage.

Intg. Mode—Right clicking on the field opens a drop-down box to specify whether the detector is integrating or non-integrating. Variable Lint specifies the integration time for acquiring an image. Variable Cfb is the Capacitive Transimpedence Amplifier (CTIA) feedback capacitance. Variable σpa is the pre-amp input-referred noise current. Well depth is the maximum electron capacity of the CTIA, and Vmax is the CTIA pre-amp saturation voltage

The Analog Electronics and ADC module 206 define the electronic conversion from an analog signal to a digital signal. The user may specify Gain, electronic analog gain; Bits, how many bits of resolution in the digital signal; Vfs, full scale output volts; σadc, input referred noise; and LSB voltage value of one digital bit.

The Performance Metrics module 208 computes various performance parameters for any pixel on the Sensor output display that the user selects, via a mouse click. Pixel x and Pixel y are the display coordinates of the selected pixel. These are the detector pixels not the “virtual pixels.” FPA out is the output voltage from the Focal Plane Assembly. ADC in is the input voltage to the Analog to Digital Converter. ADC out is the output voltage from the ADC.

The Scene is the ADC input-referred response due to the scene. As to Optics is the ADC input- referred response due to the optics. Dark indicates the ADC input-referred response due to dark current. σphoton refers to the ADC input-referred response due to photon noise. σdet refers to the ADC input-referred response due to detector shot noise. σpa refers to the ADC input-referred response due to pre-amp noise. σadc refers to the ADC input-referred noise due to ADC operation. σtotal refers to the total ADC input-referred noise.

Meanwhile, SNR is the signal to noise ratio. ξ Cutoff is the maximum spatial frequency cutoff. Airy_a is the Airy disk angular diameter in object space, and Airy_{—}1 is the Airy disk linear diameter at the FPA.

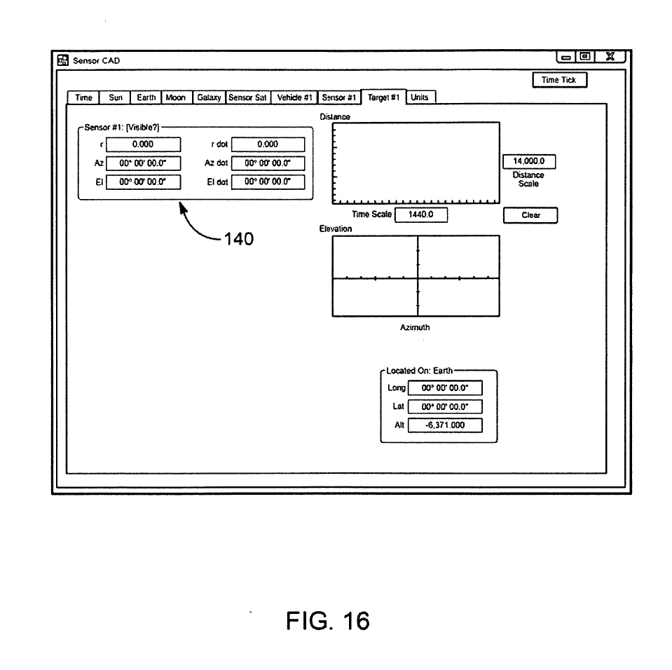

The menu screen of FIG. 16 was created for software debugging purposes. It tracks each defined Sensor from a Target's perspective. It is useful in checking the nature of the solution, but is not required to solve the sensor modeling solution.

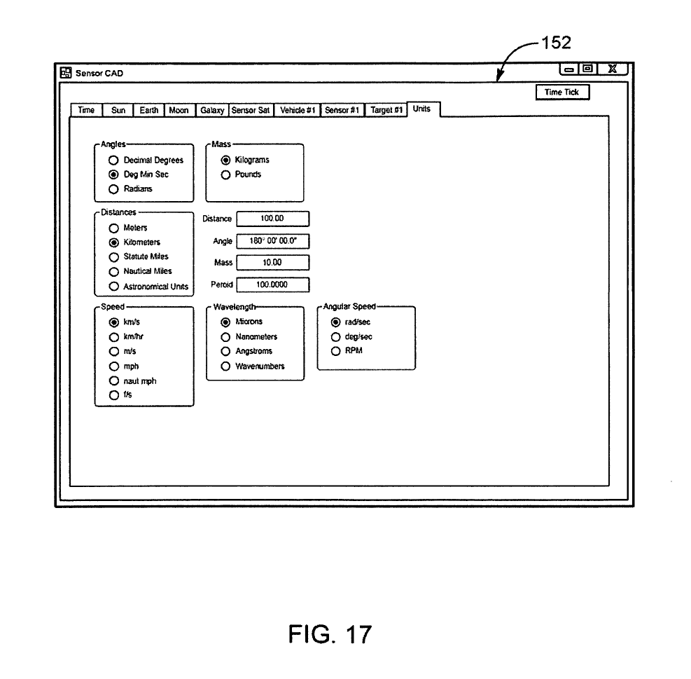

The Units menu of FIG. 17 is second of a couple of additional menus. It controls the physical units in which object parameters and current state are displayed. The user may select units that are most meaningful or convenient in his or her experience or most appropriate to the nature of the problem being simulated.

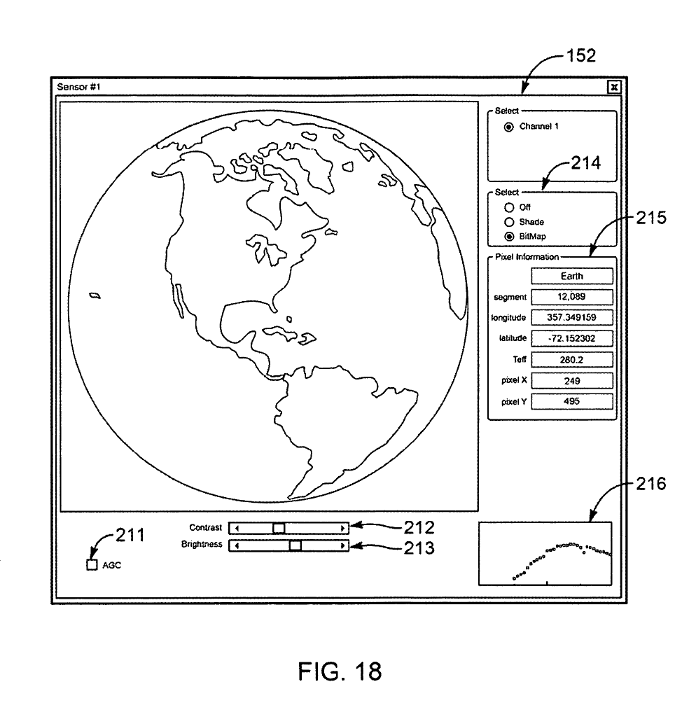

The input display of FIG. 18 shows the synthetically generated image, corresponding to the Sensor's FOV, which the Sensor model may be directed to process. Each Sensor 140 in the Simulation has its own display. The AGC checkbox 211 allows the user to have the input display apply an Automatic Gain Control algorithm to the image. This is for user convenience; it does not affect the calculated radiances or irradiances made available to the Sensor model. If AGC is not checked, the user may manually adjust the display with Contrast 212 and Brightness slide bars 213.

A radio button is displayed for each Channel. If a Sensor has more than one Channel, the input image for that channel may be selected for display by selecting the appropriate radio button.

The second Select box 214 has three radio buttons that control the quality of image processing performed by the synthetic image generator. “Off” displays only the “raw” computational elements of object surfaces, i.e. the tessellations. “Shade” applies various smoothing algorithms that smooth the boundaries between tessellations and displays secular highlights correctly. “BitMap” overlays detailed image maps onto the displayed objects. The bitmap specifies spectrally correct detailed optical properties at each bit location, such that an optically correct image may be synthesized throughout the full range (e.g., the 0.28 μm through 28.0 μm spectral range). Each successive radio button enables more computation such that the user may select an appropriate trade between computational accuracy and time to compute the answer.

The parameter selection for Pixel Information 215 allows the user to query the image by mouse clicking. For example, some items given for the selected display pixel may include the name of the simulated object which provided the image for that pixel, the computational Segment (tessellation), or if a star is clicked, its catalog number, the Latitude and Longitude on the surface of the object, Teff as the effective Temperature modeled for the tessellation (from which its blackbody radiation is computed), and the X & Y address on the display for the pixel being queried. It should be noted that for the input display the referenced pixels are the so called “virtual pixels” described above.

A second display 216 in the lower right hand corner shows the relative radiance/irradiance in each spectral interval for the spectral bandpass (λ minimum through λ maximum) selected for the Sensor, for the selected pixel.

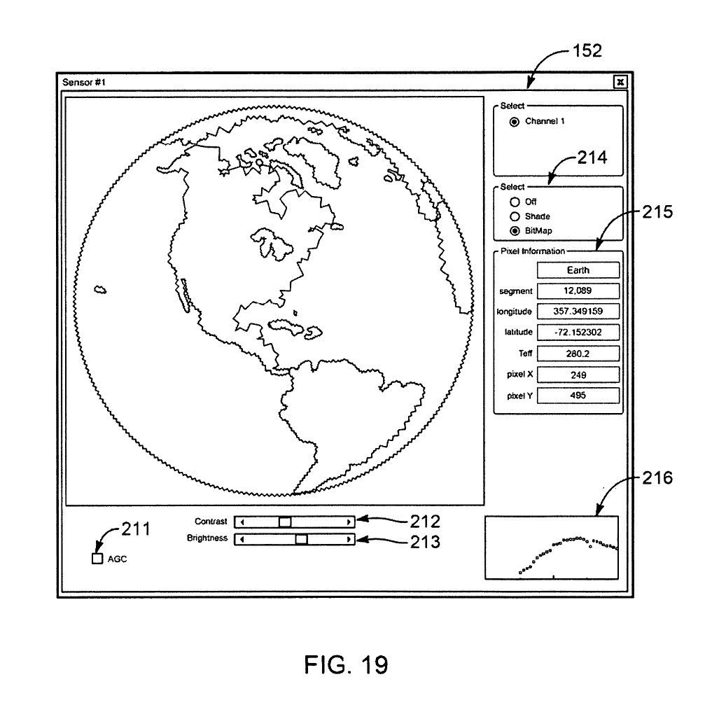

The output display of FIG. 19 shows the synthetically generated image, corresponding to the Sensor's FOV, which the Sensor model has processed. The display pixels here correspond to the parametrically defined pixels of the Sensor. The Sensor model computes a physically correct output image, based on the input image and the parametric description of the Sensor. This includes optical diffraction effects and noise sources.

### EXAMPLE I

In selected embodiments, a user interface module (e.g., GUI) provides to a user or operator control to direct the simulation by setting simulation states and parametric values and to observe the results of the simulation. Time may be a primary parameter of the simulation. Simulation results may be computed at a specific time value. Internal to the simulation, time may be maintained relative to a specific time base (e.g., J2000 time).

A control module may sequence the execution of a single simulation “time frame” (at the current value of time) in a deterministic order based on the selected objects in the universe of simulation and physical causality. The control module may also manage the progression of time from one simulation frame to the next. Time may either increment by a specified step parameter (e.g., 0.1 second) or decrement by the specified step from one simulation time frame to the next. A new simulation time frame may then be computed at this new time. Time may also increment from a start time to an end time, by the specified step parameter with a simulation time frame being computed at each intervening time value.

### EXAMPLE II

Spatial coordinates of all objects in the simulated universe may be maintained relative to a specific spatial coordinate base (e.g., such as Earth Centered Ecliptic with units of kilometers). The universe being simulated may contain representations of the objects being simulated, both natural and artificial (i.e., manmade). The operator may select via the interface module from an enumeration of objects to be included for purposes of the simulation.

Natural objects may include, but are not limited to, any body whose location and motion can be described mathematically and many are preprogrammed already, such as the sun, planets, moons, asteroids, comets, zodiacal light, stars, Milky Way galaxy, and the like. Man-made objects may include, but are not limited to, artificial satellites, missiles, ground vehicles, airborne vehicles, marine vehicles, aircraft, and the like. Satellites may be specified to be orbiting a particular parent body. Missiles may be in powered flight relative to some parent body. The various vehicle types may reside on, or in the influence of, a specified parent body. A parent body may be one of the other objects in the universe.

The physical characteristics and dynamics of the natural objects may be based on the best known scientific values and would not normally be changed by the operator. They may be modified via a software configuration file update. The physical characteristics and dynamics of the man-made objects may be changed by the operator at will by setting states and adjusting parameters through the interface module. Multiple instances of the man-made objects may be specified and uniquely identified.

Each object in a simulated universe may have a common set of functionalities or methods, which may be invoked at a specific time value. With respect to position, an object may compute the position of its center at the given time. Positions may all be converted to the single base coordinate system.

One may think of the kinematics (or dynamics) modules as providing the relative motion of any location on one body or in space between bodies with respect to any other body, and all with respect to an arbitrarily selectable base coordinate system, such as the sun, a galaxy, and arm of a galaxy, a planet, a satellite, a vehicle, or the like. One may think of this as the relative motion of any two appendages in a hierarchy of relative motion based on a common root coordinate system shared by the two.

For natural objects, this computation may be based on the celestial mechanics peculiar to that object. Stars may have position changes as a function of time due to annual parallax and proper motion. For satellites and missiles this computation may likewise be based on celestial mechanics. For vehicles, the current implementation may follow a fixed speed along an azimuth heading. For air vehicles, an altitude and an up or down angle may also be specified.

With respect to orientation, an object may compute the rotation of its internal coordinate system relative to the base coordinate system at the given time. For natural objects, the internal coordinate system may be based on an axis of rotation and a principal direction that locates 0° longitude. The axis of rotation may point at an inertial direction in space, but may both process and nutate as a function of time. The rotation rate may be fixed for solid bodies, but may be a function of latitude for gaseous bodies such as the Sun. For satellites, two of the three internal coordinate axes may be specified to some combination of Nadir pointing, sun pointing, Zenith pointing, velocity vector pointing, inertial pointing, or the like. For missiles and planet-bound vehicles, the primary axis may be in the velocity direction and any angular rates may be expressed about roll, pitch, and yaw axes.

### EXAMPLE III

With respect to temperature, an object may compute the temperature of its surface elements at the given time. The temperatures may be a function of surface characteristics of the object, internal heat sources in the object (e.g., electronic equipment or motors), environmental heat loading (e.g., sunlight impinging on the object), and the like. Spectral radiance may be the multi-valued data element fundamental to calculating radiative transfer and electro-magnetic sensor performance. It may include the electro-magnetic power density per unit of spectral interval across some range of the electro-magnetic spectrum (e.g., number of watts per square centimeter per steradian in every 0.1 micrometer interval from 0.3 to 28.0 micrometers).

### EXAMPLE IV

With respect to self-radiance, an object may compute the spectral radiance from its surface elements. For most objects, this computation may be based on the Planck function, the element temperature, and the surface emissivity. For some objects, other computations may be used (e.g., for the sun, a detailed representation of the measured solar radiance may be used). The solar spectral radiance may be temporally modified according to the current phase of the solar cycle and spatially/spectrally modified according to the phenomena of limb darkening.

Most objects in the simulated universe (e.g., planets, moons, comets, etc.) may have their surfaces divided into differential elements of area dA. Each surface element may have a normal vector, reflective and emissive properties, and, as described above, position, orientation, temperature, and self radiance. These dA elements are the increments of area used to perform numerical integration during the radiative transfer calculations. The surface shape of objects may have one of various primitive shapes (e.g., spheres, oblates, plates, boxes, cylinders, cones, etc.) or a combination of the primitive shapes connected in various offsets and orientations within a local coordinate system. Some objects such as stars may be represented as point sources of self radiance. They may or may not reflect the radiance of other objects may, if desired, and possess only temperature and self radiance.

### EXAMPLE V

Two other types of objects may also be typical in a simulated universe, namely targets and Sensors. A target may simply be a designated location on an object at which a sensor looks (e.g., the center of a satellite or vehicle a latitude, longitude, altitude, or combination thereof on a planet, moon, or space defined with respect thereto). Sensors may likewise be designated to reside at some location on an object (e.g., on a satellite, vehicle, other artificial body, or natural body, such as a surface of a planet, moon, or the like). A sensor may be designated to stare at a designated target or to observe the nearest target. It may also stare at an inertial location or sweep its line of sight (LOS) through paths or designated areas (e.g., along the ground track of the satellite or aircraft on which it resides).

### EXAMPLE VI

In selected embodiments, a list may be maintained of all the objects in a simulated universe that can contribute radiance to a scene or otherwise affect the radiance of a scene (e.g., eclipse the radiance from another object). At each time frame, every object on this list may be directed to compute its position and orientation.

A list may be maintained of all the sensors being considered in a simulated universe. After the position and orientation of all objects have been computed, each sensor may determine which objects reside in its field of view (FOV). The FOV may typically be a pyramidal or conical volume expanding outward from the Sensor with the axis of symmetry along the sensor's line of sight (LOS) (e.g., like the center of a camera's view finder). Every object found in this volume may be within the sensor's FOV. The sensor's LOS may be determined by its designated target or other pointing.

### EXAMPLE VII

In selected embodiments, certain calculations may be performed for each sensor's FOV. For each object in the sensor's FOV, each dA of that object that would be visible to the sensor may be perspective mapped (i.e., mapped from three-dimensional (distance) space onto a two-dimensional plane of angular space). This may be done, for instance, when all the objects in some 3-D volume of space are mapped onto the 2-D plane of a picture, monitor, or television screen. In addition to the perspective mapping, any eclipsing of one object by another object may be taken into account. For each non-eclipsed, mapped dA in the FOV, that dA's radiance directed toward the sensor may be calculated.

In certain embodiments, a dA's radiance may typically include two parts, namely, its self radiance, previously discussed, and its reflection of the radiants it receives from all other objects capable of illuminating it and considered in the model. The self radiance component directed toward the sensor may be the self radiance times the geometric coupling (e.g., view factor, respective areas, etc.) of the dA to the sensor aperture area as defined in any text on radiation or radiometric measurements or analysis.

For purposes of discussion, the mapped dA in the FOV may be referred to as dAₒ, with dAₙ used to reference some other dA on an object capable of illuminating dAₒ. The reflected radiance arriving at the sensor from dAₙ via dAₒ may be dAₙ's radiance times its geometric coupling with dAₒ times the surface reflective properties of dAₒ times the geometric coupling of dAₒ with the sensor aperture area. The total reflected radiance arriving at the sensor from dAₒ may be the sum over the contributions from all dAₙ capable of illuminating dAₒ.

This is effectively a numerical integration over the surfaces of all illuminating objects. The radiance from each dAₙ to dAₒ may be computed exactly as was the radiance from dA₀ to the sensor. In software terms, this calculation may be instantiated as a “recursive” function. The function may recurse once for each level of reflection. In practical terms, the number of levels may be limited to conserve computation time. This may be physically feasible since the radiation contribution may attenuate or otherwise diminish rapidly after multiple reflections.

### EXAMPLE VIII

Some objects, such as Earth, have an atmosphere that interacts with the light passing therethrough. The net effect may be to absorb light out of the beam, emit light into the beam, scatter light out of the beam, scatter light into the beam, and the like. These effects may be wavelength dependent. The effects may also depend on the path taken through the atmosphere, which may be determined by the positions of sensor and target. Season and latitude may also modify the absorption, emission, and scattering. The atmosphere thus modifies the earth's self emission and filters reflected light both incoming and outgoing.

### EXAMPLE IX

The zodiacal light may be or behave similar to an atmosphere, in that it may scatter and emit light into a scene (self radiance). Its scattering out and absorption may be negligible. Galactic tight may be treated sufficiently accurately as a self radiance and need not include reflection.

### EXAMPLE X

Scenes and Sensors may be of kinds other than those that emit, detect, or both, electro-magnetic waves or photons. Particle sensors can detect the particles emitted by particle sources, as in the detection of electron and proton plasmas emitted by the sun. Sensors may also detect electrostatic fields and may detect magnetic fields while sweeping through them (e.g., a satellite with a magnetometer measuring the earth's magnetic field).

In selected embodiments, a sensor may be a parameterized model of a physical sensor. A sensor may model and display the sensor response to the input scene for each simulation time frame and predict sensor performance as a function design parameters entered by a user. Types of sensors that may be modeled include, but are not limited to, electro-optical sensors (e.g., non-imaging and imaging radiometers, non-imaging and imaging grating spectrometers, non-imaging and imaging interferometers, etc.), polarimeters, hypertemporal sensors, microwave radiometers, radio frequency receivers, magnetometers, scintillation counters, radar systems, sonar systems, seismographs, gravimeters, floating potential probes, plasma frequency probes, and the like.

### EXAMPLE XI

In the example below, the sensor is assumed to be a generic imaging radiometer. The scene radiance in object space includes the spectral radiance at the sensor entrance aperture sampled on a regular grid at a rate at least two times the Nyquist spatial frequency in any direction. The spatial and spectral resolution of the scene radiance is higher than the sensor itself is capable of achieving. The scene point sources include the spectral irradiances at the sensor entrance aperture for each of the point sources or effective point sources in the sensor's FOV. The scene point sources may be located anywhere in the sensor FOV and, in general, are not coincident with the regular grid points. The spectral resolution of the scene point sources is higher than the sensor itself is capable of achieving.

The ideal spectral irradiance at the focal plane array (FPA) due to the scene radiance is calculated on the regular grid points. Effects which degrade image quality such as diffraction, optical aberrations, motion, vibration, etc. are simulated by convolving the ideal spectral image irradiance at each wavelength with the appropriate point spread function(s) or equivalently by multiplying the spatial frequency spectrum of the ideal image at each wavelength with the appropriate modulation transfer functions (MTFs). The image irradiance at the FPA due to each of the scene point sources is calculated on the regular grid points at each wavelength using the appropriate point spread function. The above calculations account for the spectral reflectance/transmittance of each optical element in the optical subsystem and the viewing geometry of off axis pixels with respect to the exit pupil of the optical subsystem.

The sensor computes self emissions from the optical subsystem. The self emissions from each individual optical element are computed based on the Planck function using the temperature and spectral emittance of the optical element and the product of reflectance, transmittance, or both of each optical element between the element in question and the detector. The total self emissions from the optical subsystem are computed by summing the individual self emissions over all optical elements. The image irradiance at the FPA due to the optical subsystem self emissions is calculated at the regular grid points. This calculation accounts for the viewing geometry of off-axis pixels with respect to the exit pupil of the optical subsystem.

The user may select one of several detectors for the simulation including specific photovoltaic, photoconductive, and thermal detectors. The total FPA irradiance from the scene radiance, scene point sources, and self emissions is numerically integrated over the detector active area of each pixel and over wavelength, resulting in the total flux incident on each detector. The detector electrical response due to the incident flux is calculated for each FPA pixel using equations available and appropriate for the detector technology being simulated and includes detector dark current if appropriate. These are available in commercial documentation, books, specifications, and so forth. Common detector noise sources may be added to the detector signal.

The sensor simulates a detector preamplifier for each pixel. The user may select one of several common detector preamplifier circuits to use for the simulation. The sensor includes an analog electronics subsystem which simulates the electrical transfer function from the FPA output to the ADC input. The sensor also includes an analog to digital converter (ADC) which digitizes the sensor response for each pixel.

Sensor performance estimate(s) appropriate to the user's needs are calculated. The sensor performance estimate(s) may include signal-to-noise ratio (SNR), minimum resolvable temperature difference (MRTD), NER, NESR, NEI, system MTF, etc.

The present invention may be embodied in other specific forms without departing from its fundamental functions or essential characteristics. The described embodiments are to be considered in all respects only as illustrative, and not restrictive. All changes which come within the meaning and range of equivalency of the illustrative embodiments are to be embraced within their scope.

What is claimed and desired to be secured by United States Letters Patent is:

1. A method of predicting sensor performance, the method comprising:
executing a body dynamics module to provide trajectories of bodies in space, the bodies arbitrarily selectable by a user from natural and artificial bodies existing between a inter-solar system scale and a tactical scale corresponding to an artificial, fabricated, structure;
executing a target module to provide behavior of a target comprising a first location, arbitrarily selectable by the user, arbitrarily located in space, and identifiable with respect to the bodies;
executing a radiance model determining a first radiance proceeding from the target toward a sensor located at a second location in space;
executing an environment module to determine a second radiance from the environment and the influence of the environment on the first radiance;
executing a sensor module to determine response of the sensor to a third radiance incoming to the sensor and comprising the first radiance and a second radiance; and
providing correction data effective to correct the output of the sensor to represent the first radiance based on detection of the third radiance by the sensor.

2. The method of claim 1, further comprising selecting a scale between a local proximity and an inter-solar system distance between a sensor body connected to the sensor and the target.

3. The method of claim 2, wherein the scale is selected to be an intra-solar system distance and the sensor body is selected from an artificial body and a natural body.

4. The method of claim 2, wherein the bodies further comprise at least one nebula as a natural body thereof.

5. The method of claim 2, wherein the bodies further comprise at least one star outside a solar system of the second location.

6. The method of claim 2, wherein one of the first and second locations is selected from a portion of an artificial structure selected from a building, a land vehicle, an aircraft, a watercraft, a satellite, and a missile operating within the influence of one of the natural bodies.

7. The method of claim 2, wherein the first location comprises a region of a natural body in a solar system corresponding to the sensor.

8. The method of claim 2, further comprising selecting, by the user, first and second bodies from the bodies, and wherein:
the first body is bound by gravity of the second body to move in proximity to the second body;
the target comprises at least a portion of one of the first and second bodies; and
the sensor is secured to the other of the first and second bodies.

9. The method of claim 1, further comprising:
arbitrarily selecting by a user first and second bodies from among the bodies;
selecting a scale between a local proximity and an inter-solar system distance between the first and second bodies;
the selecting, wherein at least one of the first and second bodies is selected from a structure, a vehicle, an aircraft, and a missile operating within the atmosphere of the other of the first and second bodies;
selecting the other of the first and second bodies from a naturally occurring body and an artificial body moving in the same solar system as the at least one body;
defining a sensor secured to one of the at least one and the other body; and
evaluating performance of the sensor in detecting a target location on the remaining one of the at least one and the other body.

10. A method of predicting performance of a sensor in space, the method comprising:
providing a computing system comprising a processor and a computer-readable memory device operably connected thereto;
providing executables stored in the memory device and executed by the processor, the executables comprising an input module, an output module, and modeling modules to calculate predictions of behaviors of bodies;
providing a user interface operably connecting to the input module and receiving inputs from a user selecting control parameters selecting the bodies to be modeled and radiance corresponding to each;
inputting parameters to specify the bodies, the bodies selected from natural and artificial bodies comprising
celestial bodies found in nature and astronomical in nature,
structures, manmade and stationary on the surface of a planet,
vehicles, manmade and movable about the surface of a planet,
aircraft, manmade and flying within the atmosphere of a planet, and
satellites, man-made and moving outside the atmosphere of a planet;
selecting, by the user, targets comprising locations among the selected bodies;
selecting and specifying, by the user, locations of sensors among the selected bodies;
specifying operational parameters of the sensors;
determining the position and orientation of each of the locations of the targets and sensors by modeling kinematics describing motion of the natural and artificial bodies selected;
modeling radiance originating from the targets and radiance arriving at the sensors;
modeling environmental influences on radiance, comprising determining atmospheric influence on scattering, absorption, reflection, transmittance, and re-radiation at the targets;
modeling performance of the sensors to determine radiance from the targets arriving at the sensors; and
outputting to the user the performance of the sensors.

11. A method of claim 10, further comprising:
executing a body dynamics module to provide trajectories or the bodies in space, the bodies being arbitrarily selected by the user from natural and artificial, fabricated structures;
executing a target module to provide behavior of a target comprising a first location, arbitrarily selectable by the user, arbitrarily located in space, and identifiable with respect to the bodies;
executing a radiance module determining a first radiance proceeding from the target toward the sensor located at a second location in space;
executing an environment module to determine a second radiance from the environment and the influence of the environment on the first radiance;
executing a sensor module to determine response of the sensor to a third radiance incoming to the sensor and comprising the first radiance and the second radiance; and
providing correction data effective to correct the output of the sensor to represent the first radiance based on detection of the third radiance by the sensor.

12. The method of claim 11, further comprising selecting a sensor body connected to the sensor, selecting a scale characterizing the distance of the target from the sensor, the scale being selected to be between a local proximity characterized by an inter-vehicle distance on a surface of a planet and an inter-solar system distance between natural bodies in different solar systems.

13. The method of claim 12, wherein the bodies further comprise at least one star outside a solar system of the second location.

14. The method of claim 13, wherein the bodies further comprise at least one nebula as a natural body thereof.

15. The method of claim 14, wherein the scale is selected to be an intra-solar system distance and the sensor body is selected from an artificial body and a natural body.

16. The method of claim 15, wherein one of the first and second locations is selected from a portion of an artificial structure selected from a building, a land vehicle, an aircraft, a watercraft, a satellite, and a missile operating within the influence of one of the natural bodies.

17. The method of claim 16, wherein the first location comprises a region of a natural body in a solar system corresponding to the sensor.

18. The method of claim 17, wherein:
the first body is bound by gravity of the second body to move in proximity to the second body;
the target comprises at least a portion of one of the first and second bodies; and
the sensor is secured to the other of the first and second bodies.

19. The method of claim 18, further comprising:
arbitrarily selecting by a user one of first and second bodies from among a building, a surface vehicle, an aircraft, and a missile operating within the atmosphere of the other of the first and second bodies;
selecting the other of the first and second bodies from a naturally occurring body and an artificial body moving in the same solar system as the at least one body;
defining a sensor secured to one of the at least one and the other body; and
evaluating performance of the sensor in detecting a target location on the remaining one of the at least one and the other body.

20. An article comprising a computer-readable medium storing modules executable on a processor to determine radiance response of a sensor specified at a sensor location to radiance received from a target at a target location, the sensor location and target location being selected from bodies comprising natural and artificial bodies moving in space, the modules comprising:
an input module to receive inputs specified by a user;
a user interface operably connecting to the input module and receiving inputs from the user selecting control parameters specifying bodies and radiance corresponding to each;
a database module receiving, storing, and retrieving parameters to specify bodies selected from natural and artificial bodies, the database comprising records containing data defining
celestial bodies found in nature and astronomical in nature,
structures manmade and stationary on the surface of the earth,
vehicles manmade and movable about the surface of the earth,
aircraft manmade and flying within the atmosphere of the earth,
satellites man-made and moving outside the atmosphere of the earth;
targets comprising locations selected by the user among the selected bodies;
sensors comprising devices at locations, the locations and operational parameters of the sensors selected and specified by the user among the selected bodies;
a kinematics module describing motion of the bodies to determine the positions and orientations of the targets and sensors;
a radiance module to determine radiance originating from and arriving at the bodies;
an environmental module to determine influences of the environment on radiance, comprising determining atmospheric influence on scattering, absorption, reflection, transmittance, and re-radiation at the locations of interest; and
a sensor module determining performance of the sensors in detecting radiance from the targets arriving at the sensors.
